(19) United States
(12) Patent Application Publication
(10) Pub. No.: US 2025/0247010 A1
(43) Pub. Date: Jul. 31, 2025

(54) POWER CONVERSION CIRCUIT AUTOMATICALLY SWITCHING BETWEEN FLYBACK MODE AND RESONANT MODE AND CONTROL METHOD THEREOF

(71) Applicant: Richtek Technology Corporation, Zhubei City (TW)

(72) Inventors: Ta-Yung YANG, Taoyuan City (TW); Kuo-Chi LIU, Hsinchu City (TW); Kun-Yu LIN, Zhubei City, Hsinchu County (TW); Tzu-Chen LIN, Zhubei City, Hsinchu County (TW)

(21) Appl. No.: 19/009,196

(22) Filed: Jan. 3, 2025

Related U.S. Application Data
(60) Provisional application No. 63/627,170, filed on Jan. 31, 2024.

(30) Foreign Application Priority Data
Jul. 4, 2024 (TW) 113125111

(51) Int. Cl. H02M 3/335; H02M 1/00; H02M 1/38; H02M 3/00

(52) U.S. Cl. CPC H02M 3/33592; H02M 1/0009; H02M 1/0035; H02M 1/0058; H02M 1/385; H02M 3/01

(57) ABSTRACT

A power convertor includes a resonant capacitor, a transformer, a high-side transistor, a low-side transistor, a control circuit, and a rectification circuit. The resonant capacitor is coupled between a resonant node and a ground. The transformer includes a primary coil coupled between a switch node and the resonant node and a secondary coil. The high-side transistor provides an input voltage to the switch node and the low-side transistor couples the switch node to the ground. The control circuit drives the high-side transistor and the low-side transistor based on the feedback voltage, and operates in either a flyback mode or a non-flyback mode based on the output voltage. When the output voltage is lower than the output threshold, the control circuit operates in the flyback mode and the rectification circuit half-wave rectifies the energy of the secondary coil to generate the output voltage.

### CROSS REFERENCE TO RELATED APPLICATIONS

This application claims the benefit of U.S. Provisional Application No. 63/627,170, filed on Jan. 31, 2024, the entirety of which is incorporated by reference herein.

This Application claims priority of Taiwan Patent Application No. 113125111, filed on Jul. 4, 2024, the entirety of which is incorporated by reference herein.

### BACKGROUND OF THE INVENTION

### Field of the Invention

The disclosure is generally related to a power conversion circuit and a control method thereof, and more particularly it is related to a power conversion circuit that is able to automatically switch between a flyback mode and a resonant mode, and a control method thereof.

### Description of the Related Art

With the ongoing development of portable electronic devices, the trend in power conversion circuits (like most power products) has been toward designs that provide high efficiency, high power density, high reliability, and low cost. Resonant power conversion circuits (including LLC resonant power conversion circuit, etc.) have advantages that include zero-voltage switching (ZVS) on the primary side and zero-current switching (ZCS) of the rectifier diode on the secondary side within the full load range. Frequency control is used to set the duty cycle of both the high-side and low-side transistors at 50% with no output inductor required. Lower voltage transistors can be used on the secondary side to reduce costs and also to improve efficiency, and they have been increasingly used in DC voltage converters in recent years.

However, due to the characteristics of resonant power conversion circuits, a higher switching frequency must be used when the output voltage is low or the load is light, so that the conversion efficiency of the resonant power conversion circuit is not efficient. With the demand for a wide range of output voltages, high output power, and high conversion efficiency, it is necessary to further optimize power conversion circuits to meet market demand.

### BRIEF SUMMARY OF THE INVENTION

The present invention proposes a power conversion circuit capable of operating in either a flyback mode or a resonant mode and a control method thereof. By automatically switching the power conversion circuit between the flyback mode and the resonant mode, it is helpful to provide a wide range of output voltage and high output power, and also improve conversion efficiency at light load and low output voltage.

In an embodiment, a power conversion circuit is provided, which comprises a resonant capacitor, a transformer, a high-side transistor, a low-side transistor, a control circuit, a feedback circuit, and a rectification circuit. The resonant capacitor is coupled between a resonant node and a ground. The transformer comprises a primary coil and a secondary coil, wherein the primary coil is coupled between a switch node and the resonant node. The high-side transistor provides an input voltage to the switch node based on a high-side driving signal. The low-side transistor couples the switch node to the ground based on a low-side driving signal. The control circuit generates the high-side driving signal and the low-side driving signal based on a feedback voltage, and operates in either a flyback mode or a non-flyback mode based on an output voltage. The feedback circuit generates the feedback voltage based on the output voltage. The rectification circuit full-wave or half-wave rectifies energy of the secondary coil based on the output voltage to generate the output voltage. When the output voltage is lower than an output threshold, the control circuit operates in the flyback mode and the rectification circuit half-wave rectifies the energy of the secondary coil to generate the output voltage.

According to some embodiments of the present invention, the control circuit transitions from the flyback mode to the non-flyback mode, or from the non-flyback mode to the flyback mode, based on a signal edge of the low-side driving signal.

According to some embodiments of the present invention, the secondary coil comprises a first secondary coil and a second secondary coil. When the output voltage is not less than the output threshold, the control circuit operates in the non-flyback mode and the rectification circuit full-wave rectifies the energy of the first secondary coil and the second secondary coil to generate the output voltage.

According to some embodiments of the present invention, the secondary coil comprises a first secondary coil and a second secondary coil. The first secondary coil comprises a first node and a second node, and the second secondary coil comprises a third node and a fourth node. The first node and the fourth node are both coupled to the output voltage. The rectification circuit comprises a first rectification transistor, a second rectification transistor, and a third rectification transistor. The first rectification transistor couples the second node to the ground based on a first rectification signal. The second rectification transistor couples the third node to a rectification node based on a first rectification signal. The third rectification transistor couples the rectification node to the ground based on a third rectification signal. When the output voltage is lower than the output threshold, the third rectification transistor is turned off so that the rectification circuit half-wave rectifies the energy of the second secondary coil to generate the output voltage. The third signal is synchronous with the second signal.

According to some embodiments of the present invention, the rectification circuit further comprises a secondary control circuit. The secondary control circuit comprises a synchronous rectification controller, a first divider, a first comparator, a first inverter, a first flip-flop, and a second inverter. The synchronous rectification controller generates the first rectification signal based on a voltage of the second node and generates the second rectification signal based on a voltage of the third node. The first divider divides the output voltage to generate a first divided voltage. The first comparator compares the first divided voltage to a low voltage threshold to generate a rectification comparison signal. The first inverter inverts the first rectification signal to generate a first inverted rectification signal. The first flip-flop outputs the rectification comparison signal as a fourth rectification signal based on a signal edge of the first inverted rectification signal. The second inverter inverts the fourth rectification signal to generate the third rectification signal. The second divided voltage is the output voltage multiplied by a first ratio, and the low voltage threshold is the output threshold multiplied by a second ratio. The first ratio is equal to the second ratio.

According to some embodiments of the present invention, the transformer further comprises an auxiliary coil. The auxiliary coil is coupled between an auxiliary node and the ground. The power conversion circuit further comprises a second divider dividing a voltage of the auxiliary node to generate a reflected voltage. The reflected voltage is related to the output voltage. The control circuit operates in either the flyback mode or the non-flyback mode based on the reflected voltage.

According to some embodiments of the present invention, the control circuit further comprises a mode determination circuit. The mode determination circuit comprises a first pulse generator, a determination AND gate, a sampling switch, a first determination inverter, a second pulse generator, a hold switch, a determination comparator, and a determination flip-flop. The first pulse generator generates a pulse signal based on the low-side driving signal. The determination AND gate performs a logic AND operation on the low-side driving signal and the pulse signal to generate a sampling signal. The sampling switch samples the reflected voltage based on the sampling signal and stores the reflected voltage in a sampling capacitor as a sampling voltage. The first determination inverter inverts the sampling signal to generate an inverted sampling signal. The second pulse generator generates a hold signal based on the inverted sampling signal. The hold switch samples the sampling voltage based on the hold signal and stores the sampling voltage in a hold capacitor as a hold voltage. The determination comparator compares the hold voltage to a low voltage threshold to generate a determination signal. The determination flip-flop latches the determination signal as a mode signal based on an inverse of a high-side dead-time signal. When the hold voltage is lower than the low voltage threshold, the determination signal and the mode signal are in a disabled state. When the hold voltage is not less than the low voltage threshold, the determination signal and the mode signal are in an enabled state. The low voltage threshold is the output threshold multiplied by a ratio.

According to some embodiments of the present invention, the power conversion circuit further comprises a first current detection circuit, an integrator, and a full-wave rectification device. The first current detection circuit generates a current detection signal based on a voltage of the resonant node. The integrator generates an integrated signal based on the current detection signal. The full-wave rectification device full-wave rectifies the integrated signal generated by the integrator to generate a rectified signal. The control circuit further generates the high-side driving signal and the low-side driving signal based on the rectified signal.

According to some embodiments of the present invention, the first current detection circuit comprises a first capacitor and a first resistor. The first capacitor is coupled between the resonant node and a first detection node. The first resistor is coupled between the first detection node and the ground. The first current detection circuit generates the current detection signal at the first detection node.

According to some embodiments of the present invention, the integrator comprises an integrated amplifier, a second capacitor, a second resistor, a third resistor, and a third capacitor. The integrated amplifier comprises an integrated positive input terminal, an integrated negative input terminal, and an integrated output terminal, where the integrated positive input terminal receives a reference voltage, and the integrated output terminal generates the integrated signal. The second capacitor is coupled between the first detection node and the second detection node. The second resistor is coupled between the second detection node and the integrated negative input terminal. The third resistor is coupled between the integrated negative input terminal and the integrated output terminal. The third capacitor is coupled between the integrated negative input terminal and the integrated output terminal.

According to some embodiments of the present invention, the full-wave rectification device uses a base voltage as a DC level to full-wave rectify the integrated signal to generate the rectified signal. The base voltage is equal to a sum of the reference voltage and an offset voltage. The full-wave rectification device further compares the rectified signal and a first threshold voltage to generate a crossover signal. The first threshold voltage slightly exceeds the base voltage.

According to some embodiments of the present invention, the offset voltage is determined based on a difference between an enable period of the high-side driving signal and an enable period of the low-side driving signal. The offset voltage is configured to adjust the enable period of the high-side driving signal and the enable period of the low-side driving signal so that the enable period of the high-side driving signal is close to the enable period of the low-side driving signal.

According to some embodiments of the present invention, the control circuit comprises a digital circuit, a first amplifier, a second amplifier, a second resistor, an N-type transistor, a current mirror, and a summing circuit. The digital circuit gradually increases a soft-start voltage to the feedback voltage in a predetermined period. The first amplifier comprises a first positive input terminal, a first negative input terminal, and a first output terminal, wherein the first positive input terminal receives the soft-start voltage, and the first negative input terminal is coupled to the first output terminal. The second amplifier comprises a second positive input terminal, a second negative input terminal, and a second output terminal, wherein the second positive input terminal receives a feedback threshold voltage, and the second negative terminal generates a compensation voltage. The second resistor is coupled between the second negative input terminal and the first output terminal and generating a difference current. The N-type transistor comprises a gate terminal, a drain terminal, and a source terminal, wherein the gate terminal is coupled to the second output terminal, and the source terminal is coupled to the second negative input terminal. The current mirror mirrors the difference current into at least one mapping current. The summing circuit subtracts a sawtooth wave from the compensation voltage to generate a compensation signal. When the soft-start voltage is lower than the feedback threshold voltage, the compensation voltage is equal to the feedback threshold voltage. When the soft-start voltage is not less than the feedback threshold voltage, the compensation voltage is equal to the soft-start voltage.

According to some embodiments of the present invention, when the rectified signal is lower than the first threshold voltage, the full-wave rectification device sets the crossover signal to be in the disabled state. When the rectified signal exceeds the first threshold voltage, the full-wave rectification device sets the crossover signal to be in the enabled state. In response to the crossover signal transitioning from the disabled state to the enabled state or the mode signal in the disabled state, the control circuit sets a phase signal to the enabled state. The control circuit sets the phase signal to the disabled state based on either the high-side dead-time signal or a low-side dead-time signal in the enabled state. The high-side dead-time signal controls a high-side dead time of the high-side driving signal. The low-side dead-time signal controls a low-side dead time of the low-side driving signal.

According to some embodiments of the present invention, when the high-side driving signal turns on the high-side transistor, the phase signal is in the enabled state, and the mode signal is in the enabled state, the control circuit disables the high-side driving signal in response to the rectified signal exceeding the compensation signal. When the high-side driving signal turns on the high-side transistor, the phase signal is in the enabled state, and the mode signal is in the disabled state, the control circuit disables the high-side driving signal in response to a voltage of the second detection node exceeding the compensation signal. When the high-side signal turns off the high-side transistor, the control circuit enables the low-side driving signal to turn on the low-side transistor after the low-side dead time. When the low-side driving signal turns on the low-side transistor, the phase signal is in the enabled state, and the mode signal is in the enable state, the control circuit disables the low-side driving signal in response to the rectified signal exceeding the compensation signal. When the low-side driving signal turns on the low-side transistor, the phase signal is in the enabled state, and the mode signal is in the disabled state, the control circuit disables the low-side driving signal in response to the voltage of the second detection node exceeding the compensation signal. When the low-side driving signal turns off the low-side transistor, the control circuit enables the high-side driving signal to turn on the high-side transistor after the high-side dead time.

According to some embodiments of the present invention, the control circuit further limits an enable period of the high-side driving signal and an enable period of the low-side driving signal so as not to exceed a maximum enable period. The maximum enable period is changed based on the mode signal.

According to some embodiments of the present invention, the feedback voltage decreases in response to the output voltage increasing. In response to the feedback voltage is lower than a low-power threshold voltage, the low-side dead-time signal enables a burst signal so that the control circuit operates in a burst mode based on the burst signal being enabled. When the control circuit operates in the burst mode, the high-side transistor and the low-side transistor are both turned off. A duration of the burst mode increases as output power of the output voltage decreases.

According to some embodiments of the present invention, the power conversion circuit further comprises a second current detection circuit. The second current detection circuit generates an over-current signal and a zero current signal based on the current detection signal. When a current flowing through the resonant capacitor exceeds a predetermined value, the over-current signal is in a reset state, and the control circuit disables the high-side signal and the low-side signal based on the over-current signal being in the reset state. When the current flowing through the resonant capacitor is close to zero, the zero current signal is in the enabled state, so that the control circuit enables the low-side driving signal based on the zero current signal being in the enabled state.

According to some embodiments of the present invention, the control circuit further operates in the burst mode based on the burst signal being in the enabled state and the zero current signal being in the enabled state. The burst mode starts at the high-side driving signal in the disabled state and ends at the low-side driving signal in the enabled state.

According to some embodiments of the present invention, the second current detection circuit comprises a first comparison circuit and a second comparison circuit. The first comparison circuit compares a voltage of the second detection node and an upper threshold voltage to generate the over-current signal. The second comparison circuit compares the voltage of the second detection node and a zero current threshold voltage to generate the zero current signal. When the voltage of the second detection node exceeds the upper threshold voltage or the voltage of the second detection node is lower than the lower threshold voltage, the first comparison circuit sets the over-current signal to the reset state. When the voltage of the second detection node exceeds the zero current threshold voltage, the second comparison circuit sets the zero current signal to the enabled state. The zero current threshold voltage slightly exceeds zero.

In another embodiment, a control method for controlling a power conversion circuit is provided. The power conversion circuit comprises a resonant capacitor coupled between a resonant node and a ground. The power conversion circuit comprises a transformer comprising a primary coil and a secondary coil. The power conversion circuit comprises a high-side transistor providing an input voltage to a switch node. The power conversion circuit comprises a low-side transistor coupling the switch node to the ground. The power conversion circuit comprises a rectification circuit converting energy of the secondary coil to an output voltage. The power conversion circuit comprises a feedback circuit generating a feedback voltage based on the output voltage. The primary coil is coupled between the switch node and the resonant node. The control method comprises the following steps. The high-side transistor and the low-side transistor are driven based on the feedback voltage, the output voltage, and a current flowing through the resonant capacitor. It is determined whether the output voltage is lower than an output threshold. When it is determined that the output voltage is lower than the output threshold, the rectification circuit is used to half-wave rectify the energy of the secondary coil to generate the output voltage. When it is determined that the output voltage is not less than the output threshold, the rectification circuit is used to full-wave rectify the energy of the secondary coil to generate the output voltage.

According to some embodiments of the present invention, the secondary coil comprises a first secondary coil and a second secondary coil. When the output voltage is lower than the output threshold, the rectification circuit is used to convert the energy of either the first secondary coil or the second secondary coil into the output voltage. When the output voltage is not less than the output threshold, the rectification circuit is used to convert the energy of both the first secondary coil and the second secondary coil into the output voltage.

According to some embodiments of the present invention, the transformer further comprises an auxiliary coil coupled between an auxiliary node and the ground. The control method further comprises the following steps. A divider is used to divide a voltage of the auxiliary node to generate a reflected voltage. It is determined whether the reflected voltage is lower than a low voltage threshold. When it is determined that the reflected voltage is lower than the low voltage threshold, the power conversion circuit is operated in a flyback mode. When it is determined that the reflected voltage is not less than the low voltage threshold, the power conversion circuit is operated in a non-flyback mode. When the low-side transistor is turned on, the power conversion circuit is transitioned from the flyback mode to the non-flyback mode or from the non-flyback mode to the flyback mode. The reflected voltage is related to the output voltage.

According to some embodiments of the present invention, the step of determining whether the reflected voltage is lower than the low voltage threshold further comprises the following steps. The reflected voltage is sampled to store as a sampling voltage based on the low-side transistor being turned on. The reflected voltage is sampled to store as a hold voltage based on the low-side transistor being turned off. A comparator is used to compare the hold voltage and the low voltage threshold to generate a determination signal. When the hold voltage is not less than the low voltage threshold, the determination signal is in an enabled state. When hold voltage is lower than the low voltage threshold, the determination signal is in a disabled state. The determination signal is latched as a mode signal based on a high-side dead time of the high-side transistor. The power conversion circuit is operated in the non-flyback mode when the mode signal is in the enabled state. The power conversion circuit is operated in the flyback mode when the mode signal is in the disabled state.

According to some embodiments of the present invention, the control method further comprises the following steps. A first current detection circuit is used to detect a current flowing through the resonant capacitor to generate a current detection signal. The current detection signal is integrated based on a reference voltage to generate an integrated signal. The integrated signal is full-wave rectified to generate a rectified signal. The high-side transistor and the low-side transistor are driven based on the rectified signal. The first current detection circuit comprises a first capacitor and a first resistor. The first capacitor is coupled between the resonant node and a first detection node, and the first resistor is coupled between the first detection node and the ground. The current detection signal is generated at the first detection node. A second capacitor is coupled between the first detection node and a second detection node.

According to some embodiments of the present invention, the control method further comprises the following steps. A base voltage is used as a DC level to full-wave rectify the integrated signal to generate the rectified signal. The rectified signal and a first threshold voltage are compared to generate a crossover signal. The base voltage is equal to a sum of the reference voltage and an offset voltage. The first threshold voltage slightly exceeds the base voltage.

According to some embodiments of the present invention, the control method further comprises the following steps. A soft-start voltage is gradually increased to the feedback voltage in a predetermined period. The soft-start voltage is converted to a compensation voltage. A sawtooth wave is subtracted from the compensation voltage to generate a compensation signal. When the soft-start voltage is lower than the feedback threshold voltage, the compensation voltage is equal to the feedback threshold voltage. When the soft-start voltage is not less than the feedback threshold voltage, the compensation voltage is equal to the soft-start voltage.

According to some embodiments of the present invention, the control method further comprises the following steps. When the rectified signal is lower than the first threshold voltage, the crossover signal is set to a disabled state. When the rectified signal is not less than the first threshold voltage, the crossover signal is set to an enabled state. In response to the crossover signal transitioning from the disabled state to the enabled state, a phase signal is set to the enabled state. In response to the rectified signal exceeding the compensation signal, the phase signal is set to the disabled state during a high-side dead time and a low-side dead time. The low-side dead time is a period from when the high-side transistor is turned off to when the low-side transistor is turned on. The high-side dead time is a period from when the low-side transistor is turned off to when the high-side transistor is turned on.

According to some embodiments of the present invention, the control method further comprises the following steps. When the high-side transistor is turned on, the phase signal is in the enabled state, and the power conversion circuit operates in the non-flyback mode, the high-side transistor is turned off in response to the rectified signal exceeding the compensation signal. When the high-side transistor is turned on, the phase signal is in the enabled state, and the power conversion circuit operates in the flyback mode, the high-side transistor in is turned off response to a voltage of the second detection node exceeding the compensation signal. When the high-side transistor is turned off, the low-side transistor is turned on after the low-side dead time. When the low-side transistor is turned on, the phase signal is in the enabled state, and the power conversion circuit operates in the non-flyback mode, the low-side transistor is turned off in response to the rectified signal exceeding the compensation signal. When the low-side transistor is turned on, the phase signal is in the enabled state, and the power conversion circuit operates in the flyback mode, the low-side transistor is turned off in response to the voltage of the second detection node exceeding the compensation signal. When the low-side transistor is turned off, the high-side transistor is turned on after the high-side dead time.

According to some embodiments of the present invention, the control method further comprises the following steps. The power conversion circuit is operated in a burst mode in response to the feedback voltage being lower than a low-power threshold voltage. The feedback voltage decreases as the output voltage increases. The high-side transistor and the low-side transistor are simultaneously turned off in the burst mode. A duration of the burst mode is extended in response to output power of the output voltage decreasing.

According to some embodiments of the present invention, the control method further comprises the following steps. When the current flowing through the resonant capacitor exceeds a predetermined value, the high-side transistor and the low-side transistor are simultaneously turned off. When the current flowing through the resonant capacitor is close to zero, the low-side transistor is turned on. The burst mode starts at the high-side transistor being turned off and ends at the low-side transistor being turned on.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram showing a power conversion circuit in accordance with an embodiment of the present invention;

FIG. 2 is a block diagram showing a full-wave rectification device in accordance with an embodiment of the present invention;

FIG. 3 is a waveform diagram showing the rectified signal and the integrated signal in accordance with an embodiment of the present invention;

FIG. 4 is a block diagram showing a compensation circuit in accordance with an embodiment of the present invention;

FIG. 5 is a block diagram showing a mode determination circuit in accordance with an embodiment of the present invention;

FIG. 6 is a block diagram showing a control circuit in accordance with an embodiment of the present invention;

FIG. 7 is a waveform diagram showing a control circuit operating in a non-flyback mode in accordance with an embodiment of the present invention;

FIG. 8 is a circuit diagram showing a delay time generator in accordance with an embodiment of the present invention;

FIG. 9 is a schematic diagram showing a time-to-voltage conversion circuit in accordance with an embodiment of the present invention;

FIG. 10 is a schematic diagram showing an automatic adjustment circuit in accordance with an embodiment of the present invention;

FIG. 11 is a block diagram showing an output voltage detection circuit in accordance with an embodiment of the present invention;

FIG. 12 is a waveform diagram showing a power conversion circuit operating under light load in accordance with an embodiment of the present invention;

FIG. 13 is a block diagram showing a second current detection circuit in accordance with an embodiment of the present invention;

FIG. 14 is a waveform diagram showing a power conversion circuit in accordance with an embodiment of the present invention;

FIG. 15 is a block diagram showing a secondary control circuit in accordance with an embodiment of the present invention; and

FIG. 16 is a flowchart showing a control method for controlling a power conversion circuit in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

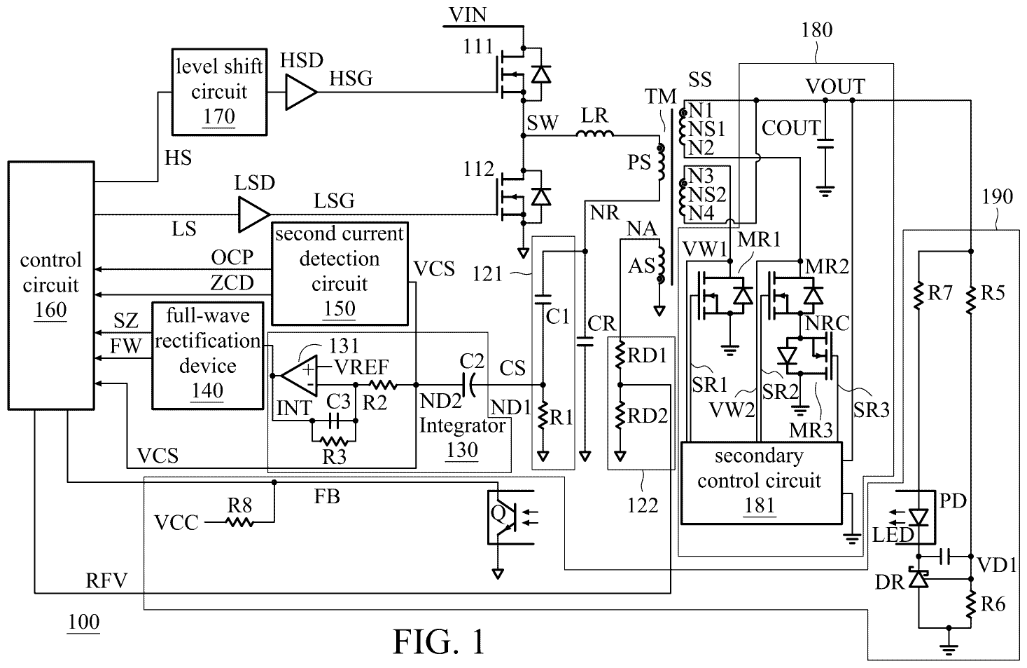

FIG. 1 is a block diagram showing a power conversion circuit in accordance with an embodiment of the present invention. As shown in FIG. 1, the power conversion circuit 100 includes a transformer TM, a resonant inductor LR, a resonant capacitor CR, an high-side transistor 111, a low-side transistor 112, a first current detection circuit 121, a first voltage divider 122, an integrator 130, a full-wave rectification device 140, a second current detection circuit 150, a control circuit 160, a level shift circuit 170, a high-side driving circuit HSD, a low-side driving circuit LSD, a rectification circuit 180, and a feedback circuit 190.

The transformer TM includes a primary coil PS and a secondary coil SS, where the primary coil PS is coupled to the resonant node NR. The resonant inductor LR is coupled between the switch node SW and the primary coil PS, and the resonant capacitor CR is coupled between the resonant node NR and the ground. According to an embodiment of the present invention, the resonant inductor LR can be replaced by the leakage inductance of the primary coil PS of the transformer TM. In other words, the primary coil PS may be coupled between the switch node SW and the resonant node NR.

As shown in FIG. 1, the secondary coil SS further includes a first secondary coil NS1 and a second secondary coil NS2. The first secondary coil NS1 includes a first endpoint N1 and a second endpoint N2, and the second secondary coil NS2 includes a third endpoint N3 and a fourth endpoint N4, where the first endpoint N1 and the fourth endpoint N4 are both coupled to the output voltage VOUT. The transformer TM further includes an auxiliary coil AS, where the auxiliary coil AS is coupled between the auxiliary node NA and the ground.

The high-side gate driving signal HSG drives the high-side transistor 111 to be conductive or non-conductive, thereby providing the input voltage VIN to the switch node SW. The low-side gate driving signal LSG drives the low-side transistor 112 to be conductive or non-conductive, thereby coupling the switch node SW to the ground. The first current detection circuit 121 includes a first capacitor Cl and a first resistor R1. The first capacitor Cl is coupled between the resonant node NR and the first detection node ND1. The first resistor R1 is coupled between the first detection node ND1 and the ground.

According to an embodiment of the present invention, the first current detection circuit 121 generates the current detection signal CS at the first detection node ND1. The first voltage divider 122 includes a first voltage dividing resistor RD1 and a second voltage dividing resistor RD2 for dividing the voltage of the auxiliary node NA to generate a reflected voltage RFV. According to an embodiment of the present invention, the reflected voltage RFV is related to the output voltage VOUT.

The integrator 130 is configured to integrate the current detection signal CS of the first detection node ND1 to generate an integrated signal INT. As shown in FIG. 1, the integrator 130 includes a second capacitor C2, a second resistor R2, an integrating amplifier 131, a third resistor R3, and a third capacitor C3. The second capacitor C2 is coupled between the first detection node ND1 and the second detection node ND2, and the second resistor R2 is coupled between the second detection node ND2 and the negative input terminal of the integrating amplifier 131. The positive input terminal of the integrating amplifier 131 receives the reference voltage VREF, and the third resistor R3 and the third capacitor C3 are connected in parallel between the output terminal and the negative input terminal of the integrating amplifier 131.

The full-wave rectification device 140 full-wave rectifies the integrated signal INT to generate the rectified signal FW and the crossover signal SZ. The second current detection circuit 150 is coupled to the second detection node ND2 and generates the over-current signal OCP and the zero-current signal ZCD according to the current detection voltage VCS of the second detection node ND2. In other words, the second current detection circuit 150 generates the over-current signal OCP and the zero-current signal ZCD based on the current detection voltage VCS of the second detection node ND2.

The control circuit 160 generates the high-side driving signal HS and the low-side driving signal LS based on the rectified signal FW, the feedback voltage FB, the over-current signal OCP, the zero-current signal ZCD, the current detection voltage VCS, and the reflected voltage RFV. The level shift circuit 170 is configured to convert the high-side driving signal HS to the voltage level of the input voltage VIN, and the high-side gate driving signal HSG is generated through the high-side driving circuit HSD to drive the high-side transistor 111. The low-side driving circuit LSD generates the low-side driving signal LSG based on the low-side driving signal HS to drive the low-side transistor 112.

According to an embodiment of the present invention, when the reflected voltage RFV is lower than the low voltage threshold VT_MD, it indicates that the output voltage VOUT is lower than the output threshold, the control circuit 160 operates in the flyback mode, and the power conversion circuit 100 is a flyback power conversion circuit. When the power conversion circuit 100 is a flyback power conversion circuit, the voltage level of the output voltage VOUT is adjusted by the conduction time of the high-side transistor 111 of the power conversion circuit 100.

According to another embodiment of the present invention, when the reflected voltage RFV is not less than the low voltage threshold VT_MD, it indicates that the output voltage VOUT is not less than the output threshold. The control circuit 160 operates in the non-flyback mode, and the power conversion circuit 100 is a resonant power conversion circuit. When the power conversion circuit 100 operates in the non-flyback mode, the power conversion circuit 100 uses the switching frequency of the high-side transistor 111 and the low-side transistor 112 to adjust the voltage level of the output voltage VOUT.

The rectification circuit 180 is coupled to the secondary coil SS and is used for full-wave or half-wave rectifying the energy of the secondary coil SS to generate the output voltage VOUT. As shown in FIG. 1, the rectification circuit 180 includes a first rectification transistor MR1, a second rectification transistor MR2, a third rectification transistor MR3, an output capacitor COUT, and a secondary control circuit 181. The first rectification transistor MR1 couples the second terminal N2 to the ground based on the first rectification signal SR1. The second rectification transistor MR2 couples the third terminal N3 to the rectification node NRC based on the second rectification signal SR2. The third rectification transistor MR3 couples the rectification node NRC to the ground based on the third rectification signal SR3.

The secondary control circuit 181 determines whether the output voltage VOUT is lower than the output threshold, and generates the first rectification signal SR1, the second rectification signal SR2, and the third rectification signal SR3 based on the first coil voltage VW1 of the third terminal N3 and the second coil voltage VW2 of the second terminal N2, so as to full-wave or half-wave rectify the energy of the first secondary coil NS1 and the second secondary coil NS2 to generate the output voltage VOUT on the output capacitor COUT. According to an embodiment of the present invention, when the output voltage VOUT is not less than the output threshold, the secondary control circuit 181 does not turn on the third rectification transistor MR3 and half-wave rectifies the energy of the second secondary coil NS2, thereby generating the output voltage VOUT. According to another embodiment of the present invention, when the output voltage VOUT is lower than the output threshold, the secondary control circuit 181 turns on the third rectification transistor MR3 to full-wave rectify the energy of the first secondary coil NS1 and the second secondary coil NS2, thereby generating the output voltage VOUT.

The feedback circuit 190 generates the feedback voltage FB based on the output voltage VOUT. As shown in FIG. 1, the feedback circuit 190 includes a fifth resistor R5, a sixth resistor R6, a voltage stabilizing element DR, an optical coupling element PD, a seventh resistor R7, and an eighth resistor R8. The fifth resistor R5 and the sixth resistor R6 are configured to divide the output voltage VOUT to generate the first divided voltage VD1. The voltage stabilizing element DR generates a current flowing through the diode LED of the optical coupling element PD based on the first divided voltage VD1 to cause the diode LED to emit light, and turns on the transistor Q of the optical coupling element PD through optical coupling.

The seventh resistor R7 is configured to limit the current flowing through the diode LED. The supply voltage VCC generates the feedback voltage FB through the eighth resistor R8 and the turned-on transistor Q. According to an embodiment of the present invention, the voltage stabilizing element DR may be TL431. According to some embodiments of the present invention, as the output voltage VOUT increases, the feedback voltage FB decreases accordingly. According to other embodiments of the present invention, as the output voltage VOUT decreases, the feedback voltage FB increases accordingly. The control method of the power conversion circuit 100 will be described in detail below.

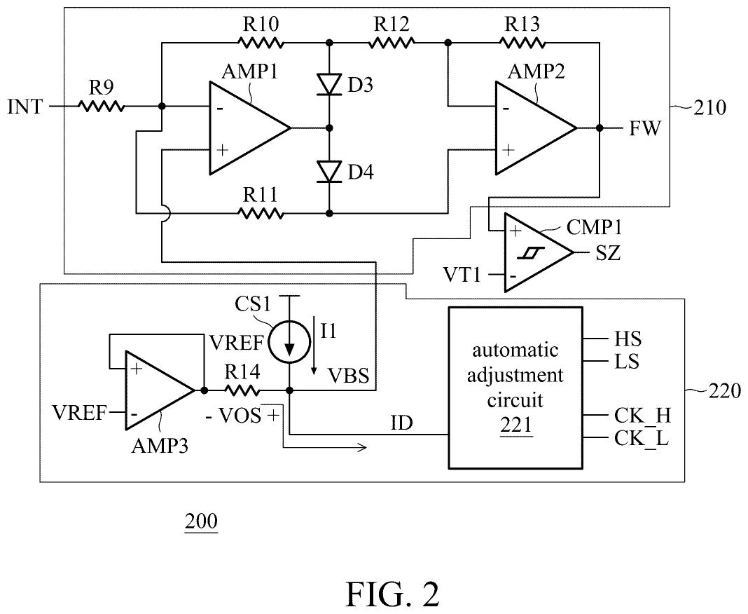

FIG. 2 is a block diagram showing a full-wave rectification device in accordance with an embodiment of the present invention. According to an embodiment of the present invention, the full-wave rectification device 200 in FIG. 2 corresponds to the full-wave rectification device 140 in FIG. 1. As shown in FIG. 2, the full-wave rectification device 200 includes a full-wave rectifier 210, a first comparator CMP1, and a bias circuit 220. The full-wave rectifier 210 includes a ninth resistor R9, a tenth resistor R10, an eleventh resistor R11, a first amplifier AMP1, a twelfth resistor R12, a thirteenth resistor R13, a third diode D3, and a fourth diode D4, and a second amplifier AMP2, where the full-wave rectifier 210 takes the basic voltage VBS as the DC level to perform full-wave rectification on the integrated signal INT generated by the integrator 130 to generate the rectified signal FW.

The first comparator CMP1 compares the rectified signal FW with the first threshold voltage VT1 to generate a crossover signal SZ. According to an embodiment of the present invention, the first threshold voltage VT1 is slightly greater than the base voltage VBS. According to an embodiment of the present invention, when the rectified signal FW is lower than the first threshold voltage VT1, the first comparator CMP1 sets the crossover signal SZ to a disabled state. According to another embodiment of the present invention, when the rectified signal FW exceeds the first threshold voltage VT1, the first comparator CMP1 sets the crossover signal SZ to an enabled state.

The bias circuit 220 includes a third amplifier AMP3, a first current source CS1, a fourteenth resistor R14, and an automatic adjustment circuit 221. As shown in FIG. 2, the positive input terminal of the third amplifier AMP3 receives the reference voltage VREF and the third amplifier AMP3 is coupled in the form of a unity-gain buffer, so that the voltage of the output terminal of the third amplifier AMP3 is equal to the reference voltage VREF. The first current source CS1 provides the first current I1 to flow to the base voltage VBS. The fourteenth resistor R14 is coupled between the base voltage VBS and the output terminal of the third amplifier AMP3.

The automatic adjustment circuit 221 extracts the adjustment current ID from the base voltage VBS based on the high-side driving signal HS, the low-side driving signal LS, the high-side dead-time signal CK_H, and the low-side dead-time signal CK_L. The automatic adjustment circuit 221, the high-side dead-time signal CK_H, and the low-side dead-time signal CK_L are described in the following paragraphs. According to an embodiment of the present invention, the base voltage VBS is equal to the sum of the reference voltage VREF and the offset voltage VOS.

According to an embodiment of the present invention, in response to the first current I1 being greater than the adjustment current ID, the offset voltage VOS is positive, and the base voltage VBS is higher than the reference voltage VREF. According to another embodiment of the present invention, since the first current I1 is less than the adjustment current ID, the offset voltage VOS is negative, and the base voltage VBS is lower than the reference voltage VREF. According to another embodiment of the present invention, in response to the first current I1 being equal to the adjustment current ID, the base voltage VBS is equal to the reference voltage VREF. According to another embodiment of the present invention, in response to the first current I1 being equal to the adjustment current ID, the offset voltage VOS is zero, and the base voltage VBS is equal to the reference voltage VREF.

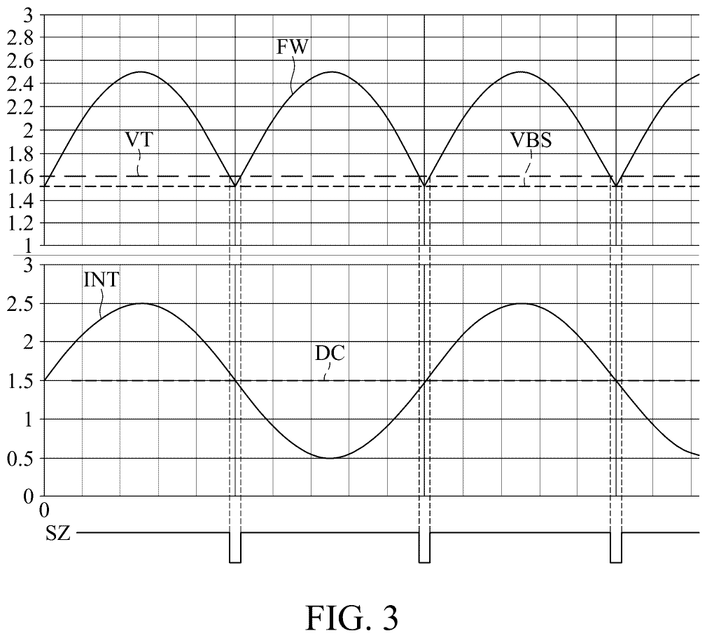

FIG. 3 is a waveform diagram showing the rectified signal and the integrated signal in accordance with an embodiment of the present invention. As shown in FIG. 3, the voltage-divided signal SD has a DC level DC, and the full-wave rectifier 210 uses the base voltage VBS as the DC level to perform full-wave rectification on the integrated signal INT to generate the rectified signal FW. Then, the first comparator CMP1 compares the rectified signal FW and the first threshold voltage VT1 to generate the crossover signal SZ. As shown in FIG. 3, when the rectified signal FW is lower than the first threshold voltage VT1, the first comparator CMP1 disables the crossover signal SZ. When the rectified signal FW is not less than the first threshold voltage VT1, the crossover signal SZ is maintained in the enabled state.

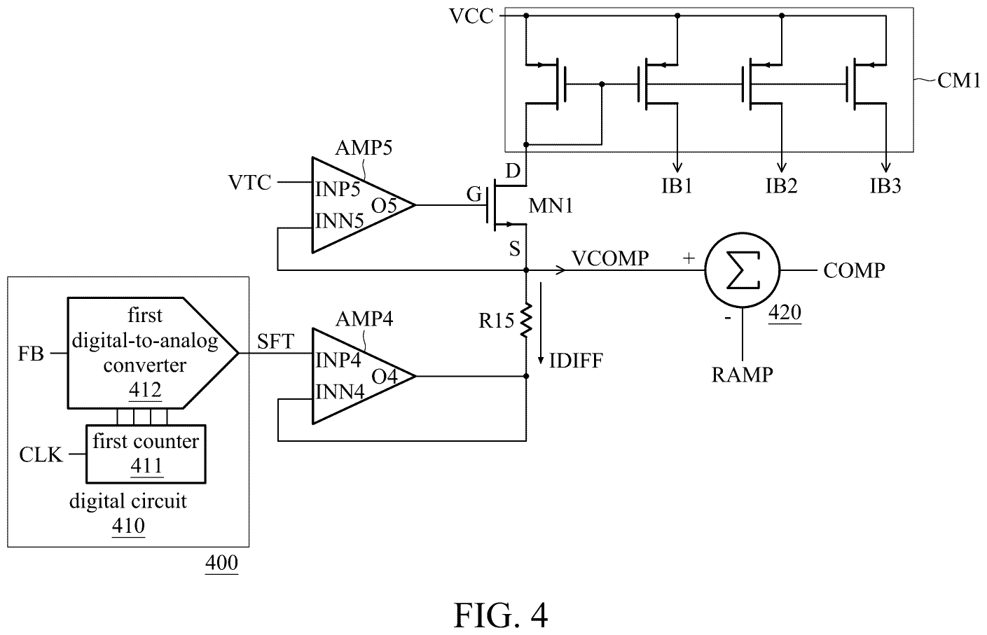

FIG. 4 is a block diagram showing a compensation circuit in accordance with an embodiment of the present invention. According to an embodiment of the present invention, the control circuit 160 in FIG. 1 includes a compensation circuit 400. As shown in FIG. 4, the compensation circuit 400 includes a digital circuit 410, a fourth amplifier AMP4, a fifth amplifier AMP5, a fifteenth resistor R15, a first N-type transistor MN1, a first current mirror CM1, and a summing circuit 420.

The compensation circuit 400 is configured to generate the compensation voltage VCOMP based on the feedback voltage FB, and limit the compensation voltage VCOMP to be not less than the feedback threshold voltage VTC. In other words, the compensation voltage VCOMP generated by the compensation circuit 400 is equal to the feedback voltage FB, and the minimum value of the compensation voltage VCOMP is limited to the feedback threshold voltage VTC. In addition, the compensation circuit 400 further subtracts the sawtooth wave RAMP from the compensation voltage VCOMP to generate the compensation signal COMP.

Once the power conversion circuit 100 starts up, the digital circuit 410 is configured to gradually increase the soft-start voltage SFT to the feedback voltage FB within a predetermined period. As shown in FIG. 4, the digital circuit 410 includes a first counter 411 and a first digital-to-analog converter 412. The first counter 411 starts counting from 0 to the maximum value according to the clock signal CLK. The first digital-to-analog converter 412 generates the soft-start voltage SFT according to the count value of the first counter 411 and the feedback voltage FB.

For example, the first counter 411 counts from 0 to 1024 according to the clock signal CLK, and the maximum value of the feedback voltage FB is 5V. Therefore, the soft-start voltage SFT increases by about 5 mV at each cycle of the clock signal CLK until the soft-start voltage SFT equals the feedback voltage FB. Since the soft-start voltage SFT is slowly increased to the correct value of the feedback voltage FB, the power conversion circuit 100 in FIG. 1 can gradually establish the output voltage VOUT.

The fourth amplifier AMP4 includes a fourth positive input terminal INP4, a fourth negative input terminal INN4, and a fourth output terminal O4, where the fourth positive input terminal INP4 receives the soft-start voltage SFT, and the fourth negative input terminal INN4 is coupled to the fourth output terminal O4. The fifth amplifier AMP5 includes a fifth positive input terminal INP5, a fifth negative input terminal INN5, and a fifth output terminal O5, where the fifth positive input terminal INP5 receives the feedback threshold voltage VTC. According to an embodiment of the present invention, the fourth amplifier AMP4 is coupled as a unity-gain amplifier, so the voltage of the fourth output terminal O4 is equal to the soft-start voltage SFT.

The fifteenth resistor R15 is coupled between the fifth negative input terminal INN5 and the fourth output terminal O4, and generates a differential current IDIFF. The first N-type transistor MN1 includes a gate terminal G, a drain terminal D, and a source terminal S. The gate terminal G is coupled to the fifth output terminal O5, and the source terminal S is coupled to the fifth negative input terminal INN5 and generates the compensation voltage VCOMP. The summing circuit 420 is configured to subtract the sawtooth wave RAMP from the compensation voltage VCOMP to generate the compensation signal COMP.

The first current mirror CM1 is coupled to the drain terminal D, and mirrors the difference current IDIFF into a first mapping current IB1, a second mapping current IB2, and a third mapping current IB3. According to some embodiments of the present invention, the first mapping current IB1, the second mapping current IB2, and the third mapping current IB3 are N, M, and P times of the difference current IDIFF respectively, where N, M and P are the mapping ratios of the first current mirror CM1. N, M, and P may be the same or different.

According to an embodiment of the present invention, when the soft-start voltage SFT is lower than the feedback threshold voltage VTC, the difference between the feedback threshold voltage VTC and the soft-start voltage SFT and the resistance value of the fifteenth resistor R15 generate a differential current IDIFF. The first current mirror CM1 generates the first mapping current IB1, the second mapping current IB2, and the third mapping current IB3, and the compensation voltage VCOMP is equal to the feedback threshold voltage VTC. According to another embodiment of the present invention, when the soft-start voltage SFT is higher than or equal to the feedback threshold voltage VTC, the fifth amplifier AMP5 turns off the first N-type transistor MN1 so that the first current mirror CM1 does not generate the first mapping current IB1, the second mapping current IB2, and the third mapping current IB3, and the compensation voltage VCOMP is equal to the soft-start voltage SFT.

In other words, when the soft-start voltage SFT is lower than the feedback threshold voltage VTC, the compensation voltage VCOMP is equal to the feedback threshold voltage VTC, and the first mapping current IB1, the second mapping current IB2, and the third mapping current IB3 are correspondingly generated. When the soft-start voltage SFT is not less than the feedback threshold voltage VTC, the compensation voltage VCOMP is equal to the soft-start voltage SFT, and the first mapping current IB1, the second mapping current IB2, and the third mapping current IB3 are not generated. The functions of the first mapping current IB1, the second mapping current IB2, and the third mapping current IB3 will be described in the following paragraphs.

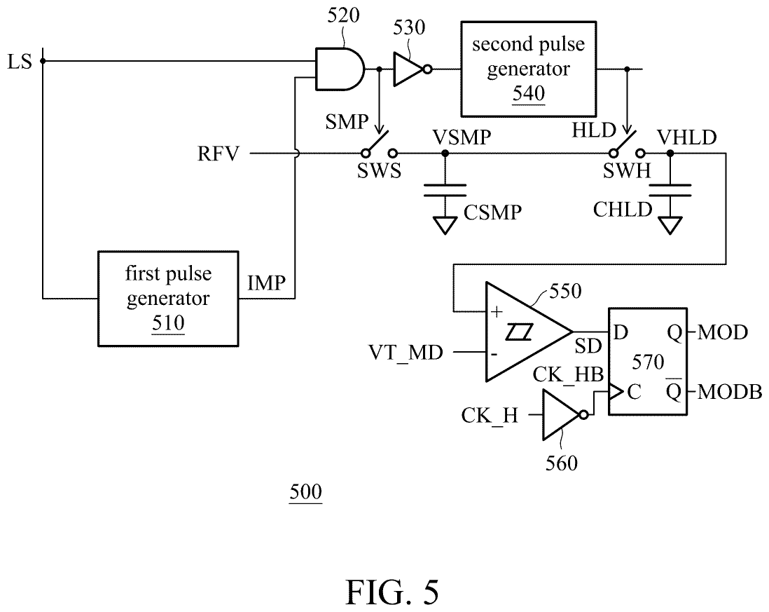

FIG. 5 is a block diagram showing a mode determination circuit in accordance with an embodiment of the present invention. According to an embodiment of the present invention, the control circuit 160 in FIG. 1 includes a mode determination circuit 500. As shown in FIG. 5, the mode determination circuit 500 includes a first pulse generator 510, a determination AND gate 520, a sampling switch SWS, a sampling capacitor CSMP, a first determination inverter 530, a second pulse generator 540, and a hold switch SWH, a hold capacitor CHLD, a determination comparator 550, a second determination inverter 560, and a determination flip-flop 570.

When the low-side driving signal LS changes from a low logic level to a high logic level, the first pulse generator 510 generates the pulse signal IMP, and the determination AND gate 520 performs a logical AND operation on the low-side driving signal LS and the pulse signal IMP to enable the sampling signal SMP, thereby turning on the sampling switch SWS. When the sampling switch SWS is turned on, the sampling switch SWS samples the reflected voltage RFV and stores it in the sampling capacitor CSMP as the sampling voltage VSMP.

The sampling signal SMP passes through the first determination inverter 530 and the second pulse generator 540 to generate the hold signal HLD, so as to turn on the hold switch SWH. When the hold switch SWH is turned on, the hold switch SWH stores the sampling voltage VSMP in the hold capacitor CHLD as the hold voltage VHLD. The determination comparator 550 compares the hold voltage VHLD with the low voltage threshold VT_MD to generate a determination signal SD.

The second determination inverter 560 inverts the high-side dead-time signal CK_H to generate an inverted high-side dead-time signal CK_HB. The determination flip-flop 560 latches the determination signal SD as the mode signal MOD based on the positive signal edge of the inverted high-side dead-time signal CK_HB, and generates the inverted mode signal MODB, where the inverted mode signal MODB is the inverse of the mode signal MOD. In other words, the determination flip-flop 560 latches the determination signal SD as the mode signal MOD based on the negative signal edge of the high-side dead-time signal CK_HB.

According to an embodiment of the present invention, when the reflected voltage RFV (i.e., the hold voltage VHLD) is lower than the low voltage threshold VT_MD, the mode signal MOD is in the disabled state, and the control circuit 160 operates in the flyback mode. According to another embodiment of the present invention, when the reflected voltage RFV (i.e., the hold voltage VHLD) is not less than the low voltage threshold VT_MD, the mode signal MOD is in the enabled state and the control circuit 160 operates in the non-flyback mode.

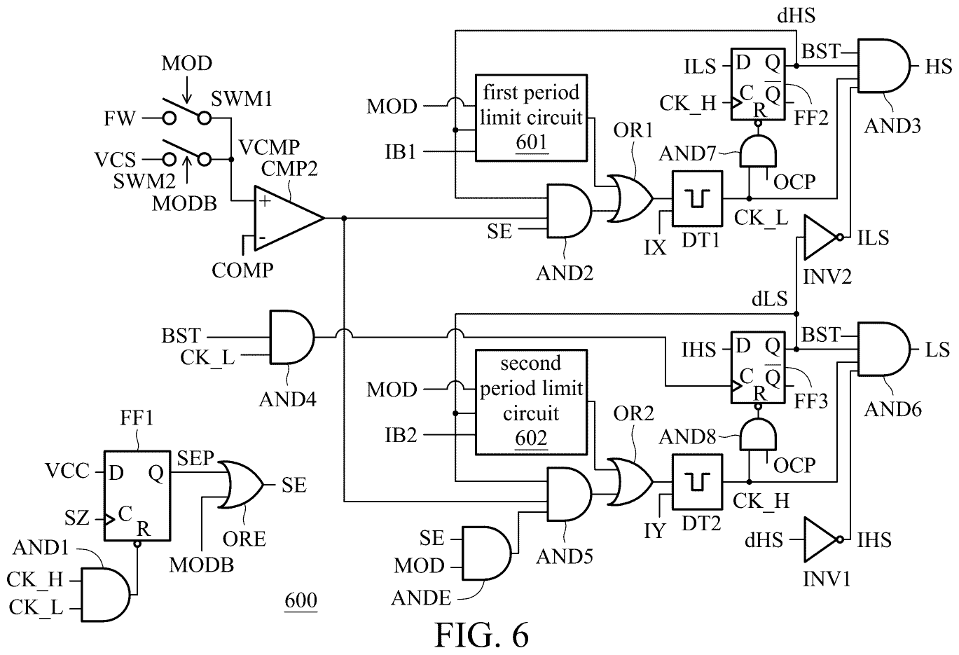

FIG. 6 is a block diagram showing a control circuit in accordance with an embodiment of the present invention. As shown in FIG. 6, the control circuit 600 includes a first flip-flop FF1, a first AND gate AND1, and a phase OR gate ORE. The first flip-flop FF1 outputs the supply voltage VCC as the pre-phase signal SEP (i.e., the pre-phase signal SEP is set to the enabled state) based on the positive signal edge of the crossover signal SZ (i.e., the crossover signal SZ changes from the disabled state to the enabled state). According to some embodiments of the present invention, the crossover signal SZ is in the disabled state when the crossover signal SZ is at the low logic level, and the crossover signal SZ is in the enabled state when the crossover signal SZ is at the high logic level. In other words, as shown in FIG. 2, when the rectified signal FW increases and exceeds the first threshold voltage VT1, the pre-phase signal SEP is enabled.

The first flip-flop FF1 further sets the pre-phase signal SEP to be in the disabled state based on the high-side dead-time signal CK_H or the low-side dead-time signal CK_L being in the disabled state (i.e., low logic level). In other words, during the high-side dead time and the high-side dead time, the leading phase signal SEP is in a disabled state. The phase OR gate ORE performs a logic OR operation on the pre-phase signal SEP and the inverted mode signal MODB to generate the phase signal SE. In other words, when the pre-phase signal SEP is in the enabled state or the mode signal MOD is in the disabled state (that is, the control circuit 600 operates in the flyback mode), the phase signal SE is in the enabled state.

As shown in FIG. 6, the control circuit 600 further includes a first mode switch SWM1, a second mode switch SWM2, a second comparator CMP2, a second AND gate AND2, a first OR gate OR1, a first dead-time generator DT1, a second flip-flop FF2, and a third AND gate AND3. When the mode signal MOD is in the enabled state (that is, the control circuit 600 operates in the non-flyback mode), the first mode switch SWM1 provides the rectified signal FW to the comparison voltage VCMP. When the inverted mode signal MODB is in the enabled state (that is, the control circuit 600 operates in the flyback mode), the second mode switch SWM2 provides the current detection voltage VCS to the comparison voltage VCMP.

When the comparison voltage VCMP exceeds the compensation signal COMP generated by the compensation circuit 400, the delayed high-side driving signal dHS is in the enabled state, and the phase signal SE is in the enabled state, the first dead time generator DT1 is triggered through the second AND gate AND2 and the first OR gate OR1 to generate a negative pulse on the low-side dead-time signal CK_L, and the high-side driving signal HS is set to the disabled state through the third AND gate AND3, thereby turning off the first The high-side transistor 110 in FIG. 1.

In addition, the negative pulse of the low-side dead-time signal CK_L resets the second flip-flop FF2, so that the delayed high-side driving signal dHS is reset to the disabled state. According to an embodiment of the present invention, the width of the negative pulse of the low-side dead-time signal CK_L is configured to determine the low-side dead time of the low-side transistor 112. According to an embodiment of the present invention, the first adjustment current IX is configured to adjust the length of the low-side dead time.

As shown in FIG. 6, the control circuit 600 further includes a first inverter INV1, a fourth AND gate AND4, a third flip-flop FF3, a mode AND gate ANDE, a fifth AND gate AND5, a second OR gate OR2, a second dead-time generator DT2, and a sixth AND gate AND6. The first inverter INV1 inverts the delayed high-side driving signal dHS being in the disabled state and sets the initial high-side driving signal IHS to the enabled state. When the low-side dead-time signal CK_L changes from the disabled state (negative pulse) to the enabled state and the burst signal BST is in the disabled state (i.e., high logic level in the embodiment of FIG. 6), the third flip-flop FF3 outputs the initial high-side driving signal IHS being in the enabled state as the delayed low-side driving signal dLS (that is, in the enabled state).

Next, when the delayed low-side driving signal dLS is in the enabled state, the comparison voltage VCMP exceeds the compensation signal COMP, the phase signal SE is in the enabled state, and the mode signal MOD is in the enabled state (that is, the control circuit 600 operates in a non-flyback mode), the second dead time generator DT2 is enabled to generate a negative pulse on the high-side dead-time signal CK_H through the mode AND gate ANDE, the fifth AND gate AND5, and the second OR gate OR2, and the low-side driving signal LS is set to the disabled state via the sixth The AND gate AND6, thereby turning off the low-side transistor 112 in FIG. 1. In addition, the negative pulse high-side dead-time signal CK_H resets the third flip-flop FF3, causing the delayed low-side driving signal dLS to be in the disabled state. According to an embodiment of the present invention, the width of the negative pulse of the high-side dead-time signal CK_H is configured to determine the high-side dead time of the high-side transistor 111. According to an embodiment of the present invention, the second adjustment current IY is configured to adjust the length of the high-side dead time.

As shown in FIG. 6, the control circuit 600 further includes a first period limit circuit 601, a second period limit circuit 602, and a second inverter INV2. When the enable period of the high-side driving signal HS exceeds the maximum enable period, the first period limit circuit 601 sends an enable signal, based on the first mapping current IB1 generated by the compensation circuit 400 in FIG. 4, to trigger the first dead-time generator DT1 to generate a negative pulse to reset (or disable) the delayed high-side driving signal dHS, thereby disabling the high-side driving signal HS. According to an embodiment of the present invention, during the enable period of the high-side driving signal HS, the high-side transistor 110 is turned on; during the enable period of the low-side driving signal LS, the low-side transistor 112 is turned on.

When the enable period of the low-side driving signal LS exceeds the maximum enable period, the second period limit circuit 602 sends an enable signal, based on the second mapping current IB2 generated by the compensation circuit 400, to trigger the second dead-time generator DT2 to generate a negative pulse to reset or disable the delayed low-side driving signal dLS, thereby disabling the low-side driving signal LS. The second inverter INV2 is configured to invert the delayed low-side driving signal dLS to generate the initial low-side driving signal ILS.

When the delayed low-side driving signal dLS is in the enabled state, the comparison voltage VCMP exceeds the compensation signal COMP, the phase signal SE is in the enabled state, and the mode signal MOD is in the disabled state (i.e., the control circuit 600 operates in the flyback mode), the output signal of the mode AND gate ANDE is in the disabled state, so that the output signal of the fifth AND gate AND5 is also in the disabled state. Therefore, the second OR gate OR2 enables the second dead-time generator DT2 to generate a negative pulse on the high-side dead-time signal CK_H based on the enable signal from the second period limit circuit 602, and sets the low-side driving signal LS to the disabled state through the sixth AND gate AND6, thereby turning off the low-side transistor 112 in FIG. 1.

In other words, when the control circuit 600 operates in the flyback mode (that is, the mode signal MOD is in the disabled state), the enable period of the low-side transistor 112 is set by the maximum enable period defined by the second period limit circuit 602. According to some embodiments of the present invention, the maximum enable periods defined by the first period limit circuit 601 and the second period limit circuit 602 may be changed based on the mode signal MOD.

As shown in FIG. 6, the control circuit 600 further includes a seventh AND gate AND7 and an eighth AND gate AND8. The seventh AND gate AND7 is configured to perform the logical AND operation on the low-side dead-time signal CK_L and the over-current signal OCP to reset the second flip-flop FF2. Specifically, when the low-side dead-time signal CK_L is at the low logic level (i.e., negative pulse) or the over-current signal OCP is at the low logic level (i.e., negative pulse), the delayed high-side driving signal dHS is reset to the disabled state.

The eighth AND gate AND8 is configured to perform the logic AND operation on the high-side dead-time signal CK_H and the overcurrent signal OCP to reset the third flip-flop FF3. Specifically, when the high-side dead-time signal CK_H is in the negative pulse state or the overcurrent signal OCP is in the negative pulse state, the delayed low-side driving signal dLS is reset to the disabled state.

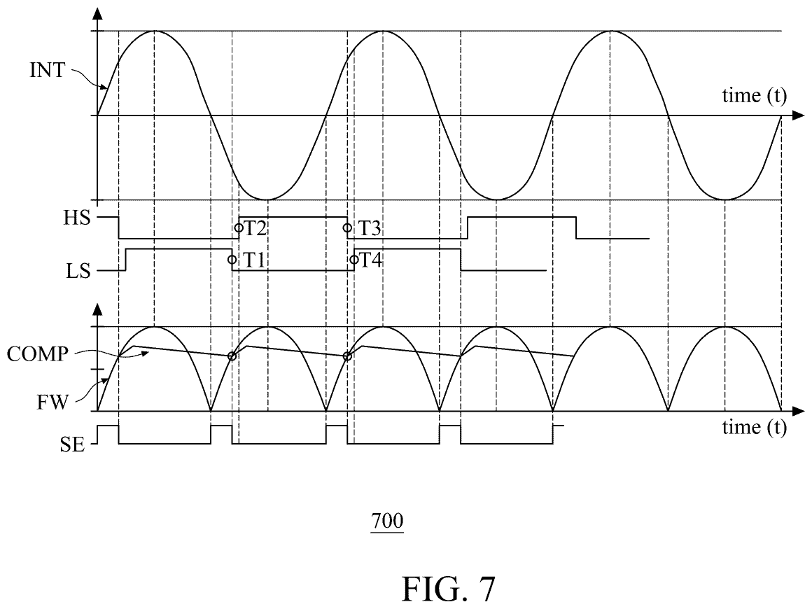

FIG. 7 is a waveform diagram showing a control circuit operating in a non-

flyback mode in accordance with an embodiment of the present invention. The control circuit 600 in FIG. 6 and the waveform diagram 700 in FIG. 7 are combined for detailed explanation.

In order to simplify the explanation, the non-flyback mode is illustrated herein for explanation. The waveform of the control circuit operating in the flyback mode can also be obtained with some modifications based on the description of the control circuit 600 in FIG. 6 and the waveform diagram 700 in FIG. 7.

At the first time point Tl in FIG. 7, the low-side driving signal LS is in the enabled state and the rectified signal FW continues to increase and happens to exceed the compensation signal COMP. As shown in FIG. 6, since the rectified signal FW exceeds the compensation signal COMP, the output of the second comparator CMP2 triggers the second dead-time generator DT2 to generate a negative pulse on the high-side dead-time signal CK_H through the fifth AND gate AND5 and the second OR gate OR2, and the negative pulse of the high-side dead-time signal CK_H resets the first flip-flop FFI to disable the phase signal SE. In addition, the negative pulse of the high-side dead-time signal CK_H simultaneously passes through the sixth AND gate AND6 to disable the low-side driving signal LS.

According to an embodiment of the present invention, when the high-side dead-time signal CK_H is in the disabled state (that is, between the first time point Tl and the second time point T2), the third flip-flop FF3 is reset to disable the delayed low-side driving signal dLS. Furthermore, the disabled delayed low-side driving signal dLS passes through the fifth AND gate AND5 and the second OR gate OR2 to stop the second dead-time generator DT2 disabling the high-side dead-time signal CK_H, thereby ending up the high-side dead time and going to the second time point T2.

At the second time point T2 in FIG. 7, the high-side dead-time signal CK_H returns to the enabled state from the negative pulse, that is, the high-side dead-time signal CK_H generates a positive signal edge at the second time point T2, so that the second flip-flops FF2 outputs the initial low-side driving signal ILS being in the enabled state as the delayed high-side driving signal dHS, and sets the high-side driving signal HS to the enabled state through the third AND gate AND3.

At the third time point T3 in FIG. 7, the high-side driving signal HS keeps in the enabled state, and the rectified signal FW continues to increase and happens to exceed the compensation signal COMP. As shown in FIG. 5, since the rectified signal FW increases and exceeds the compensation signal COMP, the output of the second comparator CMP2 triggers the first dead-time generator DT1 to generate a negative pulse on the low-side dead-time signal CK_L through the second AND gate AND2 and the first OR gate OR1, and the negative pulse of the low-side dead-time signal CK_L resets the first flip-flop FF1 to disable the phase signal SE. In addition, the negative pulse of the low-side dead-time signal CK_L simultaneously passes through the third AND gate AND3 to disable the high-side driving signal HS.

According to an embodiment of the present invention, when the low-side dead-time signal CK_L is in the disabled state, the second flip-flop FF2 is reset to disable the delayed high-side driving signal dHS, and the disabled delayed high-side driving signal dHS passes through the second AND gate AND2 and the first OR gate OR1 to stop the first dead-time generator DT1 disabling the low-side dead-time signal CK_L, so that the low-side dead-time signal CK_L returns to the enabled state.

At the fourth time point T4 in FIG. 7, the low-side dead-time signal CK_L returns to the enabled state from the negative pulse (that is, the low-side dead-time signal CK_L generates a positive signal edge at the fourth time point T4). The burst signal BST is also in the disabled state (i.e., high logic level), so that the third flip-flop FF3 outputs the initial high-side driving signal HIS being in the enabled state as the delayed low-side driving signal dLS, and sets the low-side driving signal LS to the enabled state through the sixth AND gate AND6.

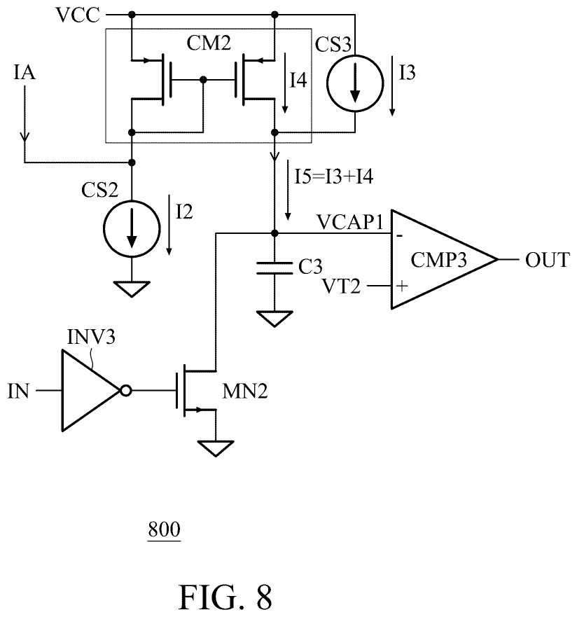

FIG. 8 is a circuit diagram showing a delay time generator in accordance with an embodiment of the present invention. According to an embodiment of the present invention, the delay time generator 800 in FIG. 8 corresponds to the first dead-time generator DT1 and the second dead-time generator DT2 in FIG. 6.

As shown in FIG. 8, the delay time generator 800 includes a third inverter INV3, a second N-type transistor MN2, a third capacitor C3, a second current source CS2, a second current mirror CM2, a third current source CS3, and third comparator CMP3.

When the input signal IN received by the third inverter INV3 is in the disabled state, the second N-type transistor MN2 is turned on and couples the first capacitor voltage VCAP1 generated by the third capacitor C3 to the ground. When the third inverter INV3 then receives the input signal IN in the enabled state, the second N-type transistor MN2 is non-conductive, and the second current mirror CM2 maps the second current I2 generated by the second current source CS2 to the fourth current I4. In addition to the third current I3 generated by the third current source CS3 in parallel with the second current mirror CM2, the third capacitor C3 is charged by the fifth current I5 to generate the first capacitor voltage VCAP1. According to an embodiment of the present invention, the fifth current I5 is the sum of the third current I3 and the fourth current I4.

When the first capacitor voltage VCAPI exceeds the second threshold voltage VT2, the third comparator CMP3 generates an output signal OUT in the disabled state. When the input signal IN returns to the disabled state again, the second N-type transistor MN2 is turned on and discharges the first capacitor voltage VCAP1 to the ground, so that the output signal OUT generated by the third comparator CMP3 returns to the enabled state again. According to an embodiment of the present invention, the fifth current I5 and the capacitance value of the third capacitor C3 determine the length of the charging period.

According to an embodiment of the present invention, when the input current IA is additionally provided to the second current source CS2, the magnitude of the fourth current I4 is reduced, thereby reducing the fifth current I5 charging the third capacitor C3, so that the period of the output signal OUT in the disabled state is extended. In other words, by increasing the size of the input current IA, the duration of the negative pulse of the output signal OUT can be adjusted. According to some embodiments of the present invention, the input current IA in FIG. 8 corresponds to the first adjustment current IX and the second adjustment current IY in FIG. 6.

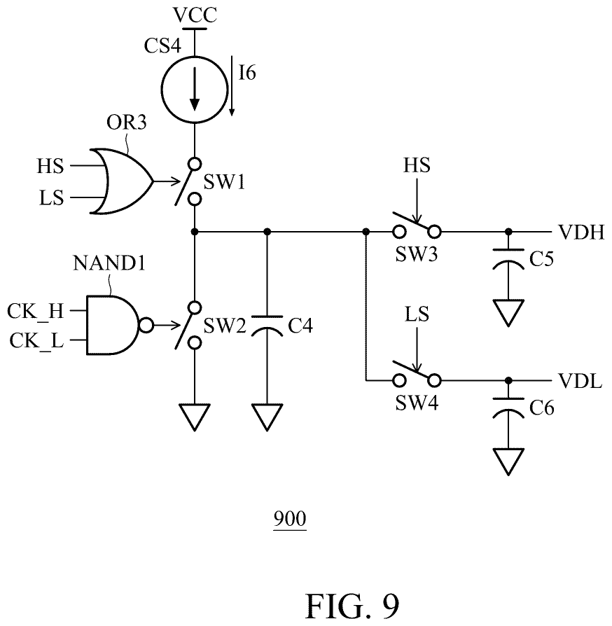

FIG. 9 is a schematic diagram showing a time-to-voltage conversion circuit in accordance with an embodiment of the present invention. According to an embodiment of the present invention, the automatic adjustment circuit 221 in FIG. 2 includes a time-to-voltage conversion circuit 900. As shown in FIG. 9, the time-to-voltage conversion circuit 900 includes a fourth current source CS4, a third OR gate OR3, a first switch SW1, a first NAND gate NAND1, a second switch SW2, a fourth capacitor C4, a third switch SW3, a fifth capacitor C5, a fourth switch SW4, and a sixth capacitor C6.

The fourth current source CS4 generates the fourth current I4, and the third OR gate OR3 performs a logic OR operation on the high-side driving signal HS and the low-side driving signal LS to turn on the first switch SW1, so that the sixth current I6 charges the fourth capacitor C4. The first NAND gate NAND1 performs a logical NAND operation on the high-side dead-time signal CK_H and the low-side dead-time signal CK_L to turn on the second switch SW2, thereby discharging the fourth capacitor C4 to the ground.

The high-side driving signal HS controls the third switch SW3, so that the sixth current I6 charges the fifth capacitor C5 to generate the high-side enable-period voltage VDH. The low-side driving signal LS controls the fourth switch SW4 so that the sixth current I6 charges the sixth capacitor C6 to generate the low-side enable-period voltage VDL.

In other words, when the high-side driving signal HS is in the enabled state, the sixth current I6 charges the fourth capacitor C4 and the fifth capacitor C5. When the low-side driving signal LS is in the enabled state, the sixth current I6 charges the fourth capacitor C4 and the sixth capacitor C6. During the high-side dead time and the low-side dead time, the fourth capacitor C4 is discharged to clear the charge stored in the fourth capacitor C4. Therefore, the high-side enable-period voltage VDH represents the enable period of the high-side driving signal HS, and the low-side enable-period voltage VDL represents the enable period of the low-side driving signal LS.

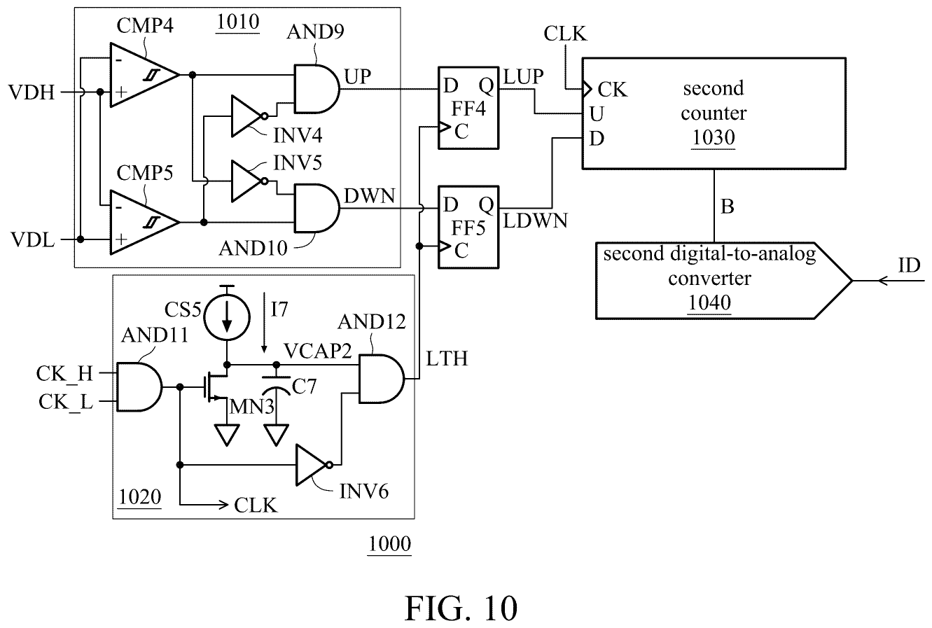

FIG. 10 is a schematic diagram showing an automatic adjustment circuit in accordance with an embodiment of the present invention. According to an embodiment of the present invention, the automatic adjustment circuit 1000 corresponds to the automatic adjustment circuit 221 in FIG. 2.

As shown in FIG. 10, the automatic adjustment circuit 1000 includes a comparison circuit 1010, a signal generation circuit 1020, a fourth flip-flop FF4, a fifth flip-flop FF5, a second counter 1030, and a second digital-to-analog converter 1040. The comparison circuit 1010 is configured to compare the high-side enable-period voltage VDH and the low-side enable-period voltage VDL to generate an up-count signal UP and a down-count signal DWN.

The signal generation circuit 1020 generates the clock signal CLK and the latch signal LTH based on the high-side dead-time signal CK_H and the low-side dead-time signal CK_L. The fourth flip-flop FF4 latches the up-count signal UP as the latched up-count signal LUP based on the latch signal LTH. The fifth flip-flop FF5 latches the down-count signal DWN as the latched down-count signal LDWN based on the latch signal LTH. The second counter 1030 counts the digital code B based on the clock signal CLK. When the latched up-count signal LUP is in the enabled state and the latched down-count signal LDWN is in the disabled state, the second counter 1030 up-counts the digital code B. When the latched up-count signal LUP is in the disabled state and the latched down-count signal LDWN is in the enabled state, the second counter 1030 down-counts the digital code B.

As shown in FIG. 10, the comparison circuit 1010 includes a fourth comparator CMP4, a fifth comparator CMP5, a fourth inverter INV4, a fifth inverter INV5, a ninth AND gate AND9, and a tenth AND gate AND10. When the high-side enable-period voltage VDH exceeds the low-side enable-period voltage VDL, the output of the fourth comparator CMP4 is in the enabled state and the output of the fifth comparator CMP5 is in the disabled state. When the high-side enable-period voltage VDH does not exceed the low-side enable-period voltage VDL, the output of the fourth comparator CMP4 is in a disabled state and the output of the fifth comparator CMP5 is in an enabled state. Then, the up-count signal UP and the down-count signal DWN are generated through the fourth inverter INV4, the fifth inverter INV5, the ninth AND gate AND9, and the tenth AND gate AND10.

In other words, when the high-side enable-period voltage VDH exceeds the low-side enable-period voltage VDL, the up-count signal UP is in the enabled state and the down-count signal DWN is in the disabled state. When the high-side enable-period voltage VDH does not exceed the low-side enable-period voltage VDL, the up-count signal UP is in a disabled state and the down-count signal DWN is in an enabled state. That is, when the enable period of the high-side driving signal HS exceeds the enable period of the low-side driving signal LS, the second counter 1030 counts the digital code B to cause the second digital-to-analog converter 1040 to increase the adjustment current ID. When the enable period of the high-side driving signal HS does not exceed the enable period of the low-side driving signal LS, the second counter 1030 down-counts the digital code B to cause the second digital-to-analog converter 1040 to decrease the adjustment current ID.

The signal generation circuit 1020 includes an eleventh AND gate AND11, a fifth current source CS5, a third N-type transistor MN3, a seventh capacitor C7, a sixth inverter INV6, and a twelfth AND gate AND12. The eleventh AND gate AND11 performs a logical AND operation on the high-side dead-time signal CK_H and the low-side dead-time signal CK_L to generate the clock signal CLK. When either the high-side dead-time signal CK_H or the low-side dead-time signal CK_L is in a negative pulse, the clock signal CLK is in a disabled state, and the seventh current I7 of the fifth current source CS5 charges the seventh capacitor C7 to generate the second capacitor voltage VCAP2, and the sixth inverter INV6 inverts the clock signal CLK, causing the latch signal LTH output by the twelfth AND gate AND12 to generate a positive signal edge, thereby triggering the fourth flip-flop FF4 and the fifth flip-flop FF5 to respectively latch the up-count signal UP and the down-count signal DWN.

According to an embodiment of the present invention, when the enable period of the high-side driving signal HS exceeds the enable period of the low-side driving signal LS, the adjustment current ID is increased to increase the offset voltage VOS and the base voltage VBS, thereby shortening the enable period of the high-side driving signal HS to extend the enable period of the low-side driving signal LS. According to another embodiment of the present invention, when the enable period of the high-side driving signal HS does not exceed the enable period of the low-side driving signal LS, the adjustment current ID is reduced to decrease the offset voltage VOS and the base voltage VBS, thereby extending the enable period of the high-side driving signal LS and shortening the enable period of the low-side driving signal LS. In other words, by adjusting the base voltage VBS, the enable period of the high-side driving signal HS is close to the enable period of the low-side driving signal LS.

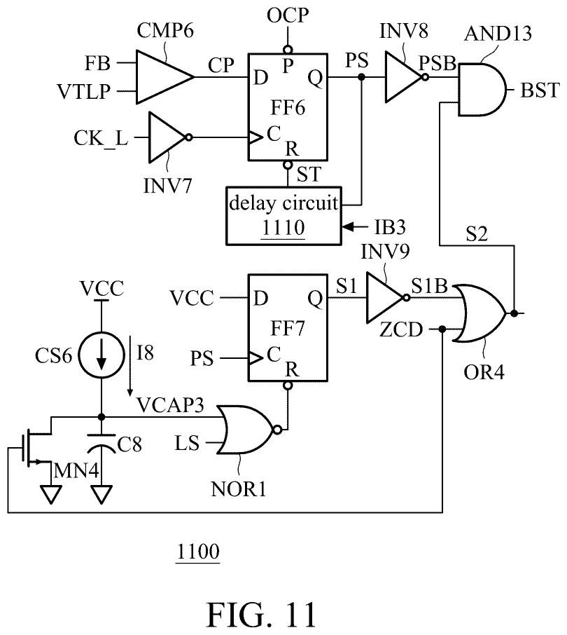

FIG. 11 is a block diagram showing an output voltage detection circuit in accordance with an embodiment of the present invention. According to an embodiment of the present invention, the control circuit 160 in FIG. 1 further includes an output voltage detection circuit 1100. As shown in FIG. 11, the output voltage detection circuit 1100 includes a sixth comparator CMP6, a sixth flip-flop FF6, a seventh inverter INV7, an eighth inverter INV8, and a delay circuit 1110.

The sixth comparator CMP6 compares the feedback voltage FB and the low-power threshold voltage VTLP to generate a comparison signal CP. According to an embodiment of the present invention, when the output voltage VOUT in FIG. 1 increases, the feedback voltage FB decreases, and the increase in the output voltage VOUT represents a decrease in the output power. In other words, when the comparison signal CP in FIG. 10 is at the high logic level, it indicates that the output power is too low.

The seventh inverter INV7 inverts the low-side dead-time signal CK_L, and triggers the sixth flip-flop FF6 to output the comparison signal CP as the pre-burst signal PSR. The pre-burst signal PSR passes through the eighth inverter INV6 to generate the inverted preamble burst signal PSB. The sixth flip-flop FF6 outputs the comparison signal CP as the pre-burst signal PSR according to the positive signal edge of the output signal of the seventh inverter INV7. In addition, when the over-current signal OCP is at the low logic level, the pre-burst signal PSR is set to the enabled state; when the reset signal ST is at the low logic level, the pre-burst signal PSR is set to the disabled state.

After receiving the inverted pre-burst signal PSB at the high logic level, the delay circuit 1110 delays a delay time to generate the reset signal ST to reset the pre-burst signal PSR, and the third mapping current IB3 in FIG. 4 is configured to adjust the delay time of the delay circuit 1110. According to an embodiment of the present invention, the delay circuit 1110 can be implemented by the delay time generator 800 in FIG. 8, where the pre-burst signal PSR corresponds to the input signal IN in FIG. 8, and the reset signal ST corresponds to the output signal OUT in FIG. 8. The detailed operation is not be repeated herein.

As shown in FIG. 11, the output voltage detection circuit 1100 further includes a fourth N-type transistor MN4, a sixth current source CS6, an eighth capacitor C8, a first NOR gate NOR1, a seventh flip-flop FF7, the ninth inverter INV9, the fourth OR gate OR4, and the thirteenth AND gate AND13.

The fourth N-type transistor MN4 is controlled by the zero current signal ZCD to discharge the third capacitor voltage VCAP3 to the ground. The eighth capacitor C8 is coupled between the third capacitor voltage VCAP3 and the ground. The sixth current source CS6 provides the eighth current I8 to charge the eighth capacitor C8 to generate the third capacitor voltage VCAP3. The seventh flip-flop FF7 enables the first signal S1 (i.e., set to the high logic level) based on the positive signal edge of the pre-burst signal PSR. The ninth inverter INV9 inverts the first signal SI to generate a first inverted signal S1B. The first NOR gate NOR 1 performs an NOR operation on the third capacitor voltage VCAP3 and the low-side driving signal LS to reset the first signal S1.

The fourth OR gate OR4 performs a logic OR operation on the first inverted signal S1B and the zero current signal ZCD to generate the second signal S2. The thirteenth AND gate AND13 performs a logic AND operation on the inverted pre-burst signal PSB and the second signal S2 to generate the burst signal BST. According to an embodiment of the present invention, when the power conversion circuit 100 returns from the burst mode to the normal operation mode (i.e., the burst signal BST transitions from the low logic level to the high logic level), the rising edge of the burst signal BST is aligned with the rising edge of the zero current signal ZCD. In other words, when the current flowing through the resonant capacitor CR is close to zero, the power conversion circuit 100 returns from the burst mode to the normal operation mode. According to some embodiments of the present invention, when the power conversion circuit 100 operates in the normal operation mode, the power conversion circuit 100 may operate in either the flyback mode or the non-flyback mode.

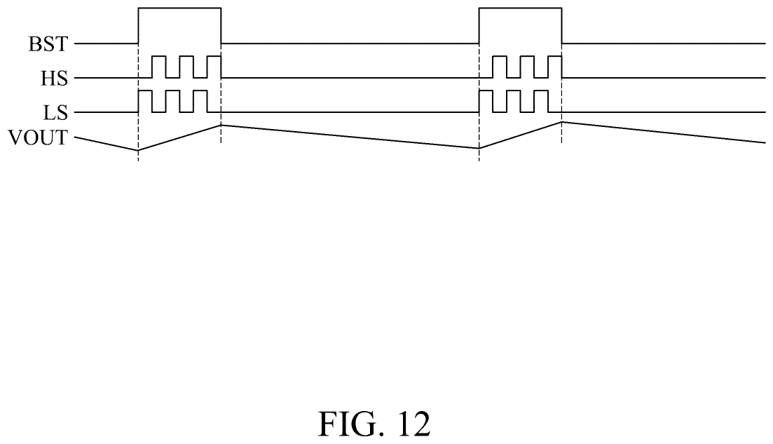

FIG. 12 is a waveform diagram showing a power conversion circuit operating under light load in accordance with an embodiment of the present invention. As shown in FIG. 12, when the burst signal BST is at the high logic level (i.e., the disabled state), the power conversion circuit 100 in FIG. 1 operates in the normal operating mode, so the high-side driving signal HS and the low-side driving modes LS are interleaved with each other to turn on the high-side transistor 111 and the low-side transistor 112 respectively.

When the output voltage VOUT continues to rise and the burst signal BST is converted to the low logic level (i.e., the enable state), the power conversion circuit 100 operates in the burst mode, so that the high-side driving signal HS and the low-side driving signal LS is maintained in the disabled state to turn off the high-side transistor 111 and the low-side transistor 112 at the same time. In addition, the falling edge of the burst signal BST is aligned with the falling edge of the high-side driving signal HS, and the rising edge of the burst signal BST is aligned with the rising edge of the low-side driving signal LS.

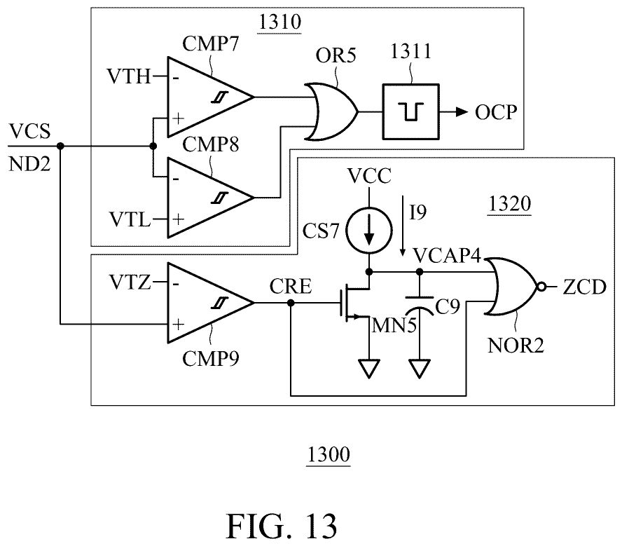

FIG. 13 is a block diagram showing a second current detection circuit in accordance with an embodiment of the present invention. According to an embodiment of the present invention, the second current detection circuit 1300 corresponds to the second current detection circuit 150 in FIG. 1, and includes a first comparison circuit 1310 and a second comparison circuit 1320.

When the current detection voltage VCS of the second current detection node ND2 exceeds the upper threshold voltage VTH or is lower than the lower threshold voltage VTL, the first comparison circuit 1310 is configured to generate a negative pulse on the over-current signal OCP. When the current detection voltage VCS exceeds the upper threshold voltage VTH or is lower than the lower threshold voltage VTL, it indicates that an over-current state occurs (that is, the current flowing through the resonant capacitor CR exceeds a predetermined value).

When the current detection voltage VCS is lower than the zero current threshold voltage VTZ, the second comparison circuit 1320 is configured to generate a negative pulse on the zero current signal ZCD. In other words, when the zero current signal ZCD is at the low logic level, it indicates that the current flowing through the resonant capacitor CR is close to zero. According to an embodiment of the present invention, the zero current threshold voltage VTZ is slightly greater than zero.

In detail, the first comparison circuit 1310 includes a seventh comparator CMP7, an eighth comparator CMP8, a fifth OR gate OR5, and a delay circuit 1311. The seventh comparator CMP7 is configured to compare the current detection voltage VCS with the upper threshold voltage VTH, and the eighth comparator CMP8 is configured to compare the current detection voltage VCS with the lower threshold voltage VTL. When the current detection voltage VCS exceeds the upper threshold voltage VTH or is lower than the lower threshold voltage VTL, the output signals of the seventh comparator CMP7 and the eighth comparator CMP8 pass through the fifth OR gate OR5 to trigger the delay circuit 1311 to generate a negative pulse on the over-current signal OCP. According to an embodiment of the present invention, the delay circuit 1311 can be implemented by the delay time generator 800 in FIG. 8, in which the output signal of the fifth OR gate OR5 corresponds to the input signal IN in FIG. 8, and the over-current signal OCP corresponds to output signal OUT in FIG. 8. The detailed operation is not be repeated herein.

The second comparison circuit 1320 includes a ninth comparator CMP9, a seventh current source CS7, a ninth capacitor C9, a fifth transistor MN5, and a second inverse-OR gate NOR2. The ninth comparator CMP9 compares the current detection voltage VCS with the zero current threshold voltage VTZ to generate a comparison result CRE. The seventh current source CS7 provides the ninth current I9 to the fourth capacitor voltage VCAP4 to charge the ninth capacitor C9. The fifth N-type transistor MN5 couples the fourth capacitor voltage VCAP4 to the ground according to the comparison result CRE. The second NOR gate NOR2 performs the logic NOR operation on the fourth capacitor voltage VCAP4 and the comparison result CRE to generate a zero current signal ZCD.

According to an embodiment of the present invention, when the comparison result CRE changes from the high logic level to the low logic level, that is, when the current detection voltage VCS drops to be less than the zero current threshold voltage VTZ, the fifth N-type The transistor MN5 is non-conductive to charge the ninth capacitor C9, thereby generating a positive pulse on the zero current signal ZCD.

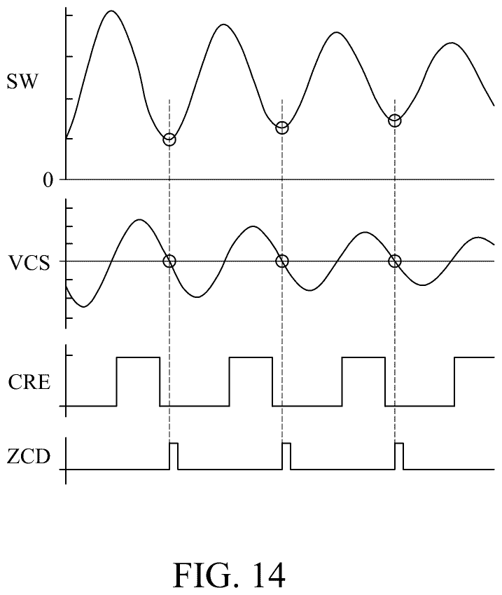

FIG. 14 is a waveform diagram showing a power conversion circuit in accordance with an embodiment of the present invention. The following description related to the waveform diagram in FIG. 14 will be combined with FIG. 1 and FIG. 13 to facilitate detailed explanation.

As shown in FIG. 1 and FIG. 13, when the power conversion circuit 100 operates, there is a signal similar to a sinusoidal wave on the switch node SW. As shown in FIG. 1, the signal at the resonant node NR is coupled to the current detection voltage VCS through the first capacitor C1 and the second capacitor C2. In other words, the current detection voltage VCS is an AC signal.

As shown in FIG. 13 and FIG. 14, when the current detection voltage VCS exceeds the zero current threshold voltage VTZ, the comparison result CRE is at the high logic level. When the current detection voltage VCS gradually decreases and is lower than the zero current threshold voltage VTZ, the comparison result CRE generates a falling edge, so that a positive pulse is generated on the zero current signal ZCD. In addition, as shown in FIG. 14, the positive pulse of the zero current signal ZCD is generated exactly near the trough position of the signal of the switch node SW.

As shown in FIG. 11, the burst signal BST is at the high logic level based on the zero current signal ZCD being at the high logic level. As shown in FIG. 11, when the burst signal BST is at the high logic level (i.e., the disabled state), the power conversion circuit 100 enters the normal operation mode. When the power conversion circuit 100 enters the normal operation mode, the low-side driving signal LS first enters the enabled state. That is, when the power conversion circuit 100 switches from the burst mode to the normal operation mode, the low-side transistor 112 is turned on first, and the low-side transistor 112 is turned on at the lowest point of the signal at the switch node SW.

In other words, when the power conversion circuit 100 switches from the burst mode to the normal operation mode, the low-side transistor 112 is turned on in the valley of the signal of the switch node SW, which helps to reduce the power loss caused by the switch switching.

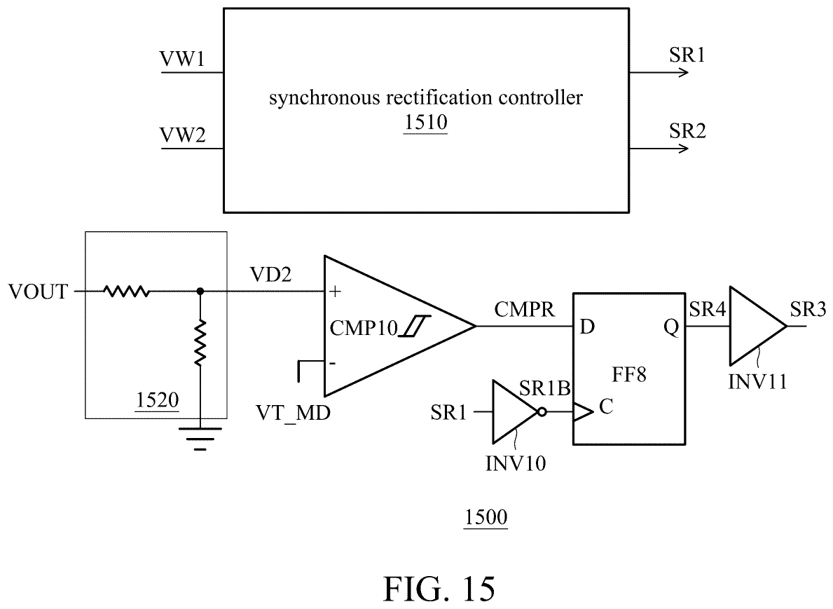

FIG. 15 is a block diagram showing a secondary control circuit in accordance with an embodiment of the present invention. According to an embodiment of the present invention, the secondary control circuit 1500 in FIG. 15 corresponds to the secondary control circuit 181 in FIG. 1.

As shown in FIG. 15, the secondary control circuit 1500 includes a synchronous rectification controller 1510, a second voltage divider 1520, a tenth comparator CMP10, a tenth inverter INV10, an eighth flip-flop FF8, and an eleventh inverter INV11. The synchronous rectification controller 1510 generates a first rectification signal SR1 based on the first coil voltage VW1, and generates a second rectification signal SR2 based on the second coil voltage VW2, thereby controlling the first rectification transistor MR1 and the second rectification transistor MR2 in FIG. 1.

The second voltage divider 1520 divides the output voltage VOUT to generate a second divided voltage VD2. The tenth comparator CMP10 is configured to compare the second divided voltage VD2 with the low voltage threshold VT_MD to generate a rectification comparison signal CMPR. According to an embodiment of the present invention, when the second divided voltage VD2 is not less than the low voltage threshold VT_MD, the rectification comparison signal CMPR is in the enabled state. According to another embodiment of the present invention, when the second divided voltage VD2 is lower than the low voltage threshold VT_MD, the rectification comparison signal CMPR is in the disabled state.

According to an embodiment of the present invention, the second divided voltage VD2 is the output voltage VOUT multiplied by the first ratio, and the low voltage threshold VT_MD is the output threshold multiplied by the second ratio, where the first ratio equal to the second ratio. According to some embodiments of the present invention, the second divided voltage VD2 is equal to the reflected voltage RFV. According to other embodiments of the present invention, the second divided voltage VD2 may not be equal to the reflected voltage RFV. This is only for illustrative explanation herein, but not intended to be limited thereto.

The tenth inverter INV10 inverts the first rectification signal SR1 to generate a first inverted rectification signal SR1B. The eighth flip-flop FF8 outputs the rectification comparison signal CMPR as the fourth rectification signal SR4 based on the signal edge of the first inverted rectification signal SR1B. The eleventh inverter INV11 inverts the fourth rectification signal SR4 to generate a third rectification signal SR3, where the third rectification signal SR3 is configured to drive the third rectification transistor MR3 in FIG. 1.

In other words, when the control circuit 160 in FIG. 1 operates in the non-flyback mode, the third rectification transistor MR3 is turned on, so that the rectification circuit 180 in FIG. 1 full-wave rectifies the first secondary coil NS1 and the second secondary coil NS2 to generate the output voltage VOUT, and the third rectification signal SR3 is synchronized with the first rectification signal SR1. When the control circuit in FIG. 1 operates in the flyback mode, the third rectification transistor MR3 is non-conductive, causing the rectification circuit 180 in FIG. 1 to half-wave rectify the energy of the second secondary coil NS2 to generate the output voltage VOUT, and the third rectification signal SR3 is synchronized with the first rectification signal SR1.

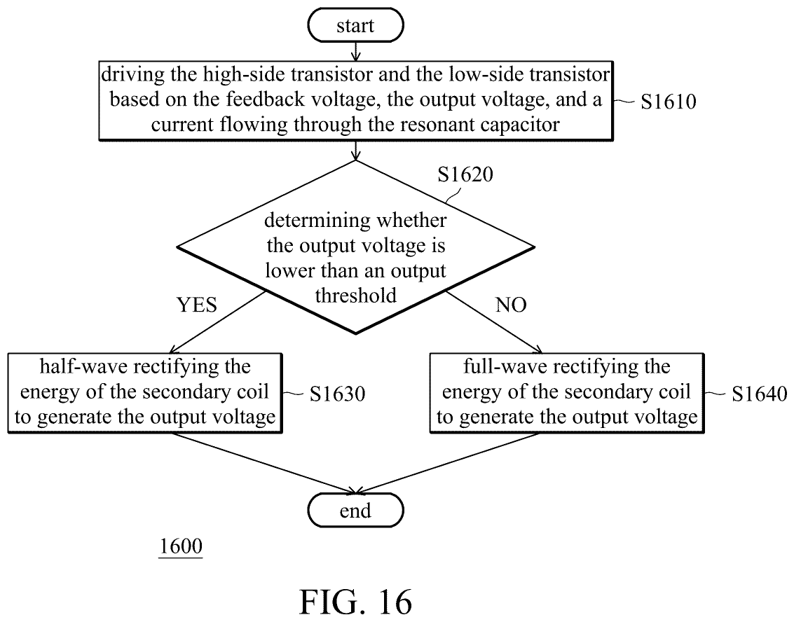

FIG. 16 is a flowchart showing a control method for controlling a power conversion circuit in accordance with an embodiment of the present invention. The following description of the control method 1600 in FIG. 16 will be combined with the power conversion circuit 100 in FIG. 1 to facilitate detailed explanation.

The control circuit 160 in FIG. 1 is configured to drive the high-side transistor 111 and the low-side transistor 112 based on the feedback voltage FB, the output voltage VOUT, and the current flowing through the resonant capacitor CR (Step S1610). More specifically, the reflected voltage RFV is related to the output voltage VOUT. The mode determination circuit 500 (as shown in FIG. 5) of the control circuit 160 uses the reflected voltage RFV related to the output voltage VOUT to determine whether to operate in the flyback mode or the non-flyback mode.

In addition, the control circuit 160 drives the high-side transistor 111 and the low-side transistor 112 based on the rectified signal FW generated by the full-wave rectification device 140, the over-current signal OCP and the zero-current signal ZCD generated by the second current detection circuit 150, and the current detection voltage VCS of the second detection node ND2. The detailed operations have been explained in in FIG. 2, FIG. 4, and FIG. 6, and will not be repeated herein.

Next, the rectification circuit 180 is configured to determine whether the output voltage VOUT is lower than the output threshold (Step S1620). When it is determined that the output voltage VOUT is lower than the output threshold, the power conversion circuit 100 is operated in the flyback mode and uses the rectification circuit 180 to half-wave rectify the energy of the secondary coil SS to generate the output voltage VOUT (Step S1630). When it is determined that the output voltage VOUT is not less than the output threshold, the power conversion circuit 100 is operated in the non-flyback mode and the rectification circuit 180 is configured to full-wave rectify the energy of the secondary coil SS to generate the output voltage VOUT (Step S1640).

As shown in FIG. 15, the second voltage divider 1520 and the tenth comparator CMP10 determine whether the second divided voltage VD2 is lower than the low voltage threshold VT_MD, and then generate a third rectification signal SR3 to control the third rectification transistor MR3. The synchronous rectification controller 1510 generates the first rectification signal SR1 based on the first coil voltage VW1, and generates the second rectification signal SR2 based on the second coil voltage VW2. The third rectification signal SR3 is synchronous with the signal edge of the second rectification signal SR2.

According to an embodiment of the present invention, the second divided voltage VD2 is the output voltage VOUT multiplied by the first ratio, and the low voltage threshold VT_MD is the output threshold multiplied by the second ratio, where the first ratio equal to the second ratio.

The present invention proposes a power conversion circuit capable of operating in either a flyback mode or a resonant mode and a control method thereof. By automatically switching the power conversion circuit between the flyback mode and the resonant mode, it is helpful to provide a wide range of output voltage and high output power, and also improve conversion efficiency at light load and low output voltage.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a resonant capacitor, coupled between a resonant node and a ground;
a transformer, comprising a primary coil and a secondary coil, wherein the primary coil is coupled between a switch node and the resonant node;
a high-side transistor, providing an input voltage to the switch node based on a high-side driving signal;
a low-side transistor, coupling the switch node to the ground based on a low-side driving signal;
a control circuit, generating the high-side driving signal and the low-side driving signal based on a feedback voltage, and operating in either a flyback mode or a non-flyback mode based on an output voltage;
a feedback circuit, generating the feedback voltage based on the output voltage; and
a rectification circuit, full-wave or half-wave rectifying energy of the secondary coil based on the output voltage to generate the output voltage;
wherein when the output voltage is lower than an output threshold, the control circuit operates in the flyback mode and the rectification circuit half-wave rectifies the energy of the secondary coil to generate the output voltage.

2. The power conversion circuit as claimed in claim 1, wherein the control circuit transitions from the flyback mode to the non-flyback mode, or from the non-flyback mode to the flyback mode, based on a signal edge of the low-side driving signal.

3. The power conversion circuit as claimed in claim 1, wherein the secondary coil comprises a first secondary coil and a second secondary coil, wherein when the output voltage is not less than the output threshold, the control circuit operates in the non-flyback mode and the rectification circuit full-wave rectifies the energy of the first secondary coil and the second secondary coil to generate the output voltage.

4. The power conversion circuit as claimed in claim 1, wherein the secondary coil comprises a first secondary coil and a second secondary coil, wherein the first secondary coil comprises a first node and a second node, and the second secondary coil comprises a third node and a fourth node, wherein the first node and the fourth node are both coupled to the output voltage;
wherein the rectification circuit comprises:
a first rectification transistor, coupling the second node to the ground based on a first rectification signal;
a second rectification transistor, coupling the third node to a rectification node based on a first rectification signal; and
a third rectification transistor, coupling the rectification node to the ground based on a third rectification signal;
wherein when the output voltage is lower than the output threshold, the third rectification transistor is turned off so that the rectification circuit half-wave rectifies the energy of the second secondary coil to generate the output voltage;
wherein the third signal is synchronous with the second signal.

5. The power conversion circuit as claimed in claim 4, wherein the rectification circuit further comprises:
a secondary control circuit, comprising:
a synchronous rectification controller, generating the first rectification signal based on a voltage of the second node and generating the second rectification signal based on a voltage of the third node;
a first divider, dividing the output voltage to generate a first divided voltage;
a first comparator, comparing the first divided voltage to a low voltage threshold to generate a rectification comparison signal;
a first inverter, inverting the first rectification signal to generate a first inverted rectification signal;
a first flip-flop, outputting the rectification comparison signal as a fourth rectification signal based on a signal edge of the first inverted rectification signal; and
a second inverter, inverting the fourth rectification signal to generate the third rectification signal;
wherein the second divided voltage is the output voltage multiplied by a first ratio, and the low voltage threshold is the output threshold multiplied by a second ratio;
wherein the first ratio is equal to the second ratio.

6. The power conversion circuit as claimed in claim 1, wherein the transformer further comprises:
an auxiliary coil, coupled between an auxiliary node and the ground;
wherein the power conversion circuit further comprises a second divider dividing a voltage of the auxiliary node to generate a reflected voltage;
wherein the reflected voltage is related to the output voltage;
wherein the control circuit operates in either the flyback mode or the non-flyback mode based on the reflected voltage.

7. The power conversion circuit as claimed in claim 6, wherein the control circuit further comprises:
a mode determination circuit, comprising:
a first pulse generator, generating a pulse signal based on the low-side driving signal;
a determination AND gate, performing a logic AND operation on the low-side driving signal and the pulse signal to generate a sampling signal;
a sampling switch, sampling the reflected voltage based on the sampling signal and storing the reflected voltage in a sampling capacitor as a sampling voltage;
a first determination inverter, inverting the sampling signal to generate an inverted sampling signal;
a second pulse generator, generating a hold signal based on the inverted sampling signal;
a hold switch, sampling the sampling voltage based on the hold signal and storing the sampling voltage in a hold capacitor as a hold voltage;
a determination comparator, comparing the hold voltage to a low voltage threshold to generate a determination signal; and
a determination flip-flop, latching the determination signal as a mode signal based on an inverse of a high-side dead-time signal;
wherein when the hold voltage is lower than the low voltage threshold, the determination signal and the mode signal are in a disabled state;
wherein when the hold voltage is not less than the low voltage threshold, the determination signal and the mode signal are in an enabled state;
wherein the low voltage threshold is the output threshold multiplied by a ratio.

8. The power conversion circuit as claimed in claim 7, further comprising:
a first current detection circuit, generating a current detection signal based on a voltage of the resonant node;
an integrator, generating an integrated signal based on the current detection signal; and
a full-wave rectification device, full-wave rectifying the integrated signal generated by the integrator to generate a rectified signal;
wherein the control circuit further generates the high-side driving signal and the low-side driving signal based on the rectified signal.

9. The power conversion circuit as claimed in claim 8, wherein the first current detection circuit comprises:
a first capacitor, coupled between the resonant node and a first detection node; and
a first resistor, coupled between the first detection node and the ground;
wherein the first current detection circuit generates the current detection signal at the first detection node.

10. The power conversion circuit as claimed in claim 9, wherein the integrator comprises:
an integrated amplifier, comprising an integrated positive input terminal, an integrated negative input terminal, and an integrated output terminal, wherein the integrated positive input terminal receives a reference voltage, and the integrated output terminal generates the integrated signal;
a second capacitor, coupled between the first detection node and the second detection node;
a second resistor, coupled between the second detection node and the integrated negative input terminal;
a third resistor, coupled between the integrated negative input terminal and the integrated output terminal; and
a third capacitor, coupled between the integrated negative input terminal and the integrated output terminal.

11. The power conversion circuit as claimed in claim 10, wherein the full-wave rectification device uses a base voltage as a DC level to full-wave rectify the integrated signal to generate the rectified signal;
wherein the base voltage is equal to a sum of the reference voltage and an offset voltage;
wherein the full-wave rectification device further compares the rectified signal and a first threshold voltage to generate a crossover signal;
wherein the first threshold voltage slightly exceeds the base voltage.

12. The power conversion circuit as claimed in claim 11, wherein the offset voltage is determined based on a difference between an enable period of the high-side driving signal and an enable period of the low-side driving signal;
wherein the offset voltage is configured to adjust the enable period of the high-side driving signal and the enable period of the low-side driving signal so that the enable period of the high-side driving signal is close to the enable period of the low-side driving signal.

13. The power conversion circuit as claimed in claim 11, wherein the control circuit comprises:
a digital circuit, gradually increasing a soft-start voltage to the feedback voltage in a predetermined period;
a first amplifier, comprising a first positive input terminal, a first negative input terminal, and a first output terminal, wherein the first positive input terminal receives the soft-start voltage, and the first negative input terminal is coupled to the first output terminal;
a second amplifier, comprising a second positive input terminal, a second negative input terminal, and a second output terminal, wherein the second positive input terminal receives a feedback threshold voltage, and the second negative terminal generates a compensation voltage;
a second resistor, coupled between the second negative input terminal and the first output terminal and generating a difference current;
an N-type transistor, comprising a gate terminal, a drain terminal, and a source terminal, wherein the gate terminal is coupled to the second output terminal, and the source terminal is coupled to the second negative input terminal;
a current mirror, mirroring the difference current into at least one mapping current; and
a summing circuit, subtracting a sawtooth wave from the compensation voltage to generate a compensation signal;
wherein when the soft-start voltage is lower than the feedback threshold voltage, the compensation voltage is equal to the feedback threshold voltage;
wherein when the soft-start voltage is not less than the feedback threshold voltage, the compensation voltage is equal to the soft-start voltage.

14. The power conversion circuit as claimed in claim 13, wherein when the rectified signal is lower than the first threshold voltage, the full-wave rectification device sets the crossover signal to be in the disabled state;
wherein when the rectified signal exceeds the first threshold voltage, the full-wave rectification device sets the crossover signal to be in the enabled state;
wherein in response to the crossover signal transitioning from the disabled state to the enabled state or the mode signal in the disabled state, the control circuit sets a phase signal to the enabled state;
wherein the control circuit sets the phase signal to the disabled state based on either the high-side dead-time signal or a low-side dead-time signal in the enabled state;
wherein the high-side dead-time signal controls a high-side dead time of the high-side driving signal;
wherein the low-side dead-time signal controls a low-side dead time of the low-side driving signal.

15. The power conversion circuit as claimed in claim 14, wherein when the high-side driving signal turns on the high-side transistor, the phase signal is in the enabled state, and the mode signal is in the enabled state, the control circuit disables the high-side driving signal in response to the rectified signal exceeding the compensation signal;
wherein when the high-side driving signal turns on the high-side transistor, the phase signal is in the enabled state, and the mode signal is in the disabled state, the control circuit disables the high-side driving signal in response to a voltage of the second detection node exceeding the compensation signal;
wherein when the high-side signal turns off the high-side transistor, the control circuit enables the low-side driving signal to turn on the low-side transistor after the low-side dead time;
wherein when the low-side driving signal turns on the low-side transistor, the phase signal is in the enabled state, and the mode signal is in the enable state, the control circuit disables the low-side driving signal in response to the rectified signal exceeding the compensation signal;
wherein when the low-side driving signal turns on the low-side transistor, the phase signal is in the enabled state, and the mode signal is in the disabled state, the control circuit disables the low-side driving signal in response to the voltage of the second detection node exceeding the compensation signal;
wherein when the low-side driving signal turns off the low-side transistor, the control circuit enables the high-side driving signal to turn on the high-side transistor after the high-side dead time.

16. The power conversion circuit as claimed in claim 14, wherein the control circuit further limits an enable period of the high-side driving signal and an enable period of the low-side driving signal so as not to exceed a maximum enable period;
wherein the maximum enable period is changed based on the mode signal.

17. The power conversion circuit as claimed in claim 14, wherein the feedback voltage decreases in response to the output voltage increasing;
wherein in response to the feedback voltage is lower than a low-power threshold voltage, the low-side dead-time signal enables a burst signal so that the control circuit operates in a burst mode based on the burst signal being enabled;
wherein when the control circuit operates in the burst mode, the high-side transistor and the low-side transistor are both turned off;
wherein a duration of the burst mode increases as output power of the output voltage decreases.

18. The power conversion circuit as claimed in claim 17, further comprising:
a second current detection circuit, generating an over-current signal and a zero current signal based on the current detection signal;
wherein when a current flowing through the resonant capacitor exceeds a predetermined value, the over-current signal is in a reset state, and the control circuit disables the high-side signal and the low-side signal based on the over-current signal being in the reset state;
wherein when the current flowing through the resonant capacitor is close to zero, the zero current signal is in the enabled state, so that the control circuit enables the low-side driving signal based on the zero current signal being in the enabled state.

19. The power conversion circuit as claimed in claim 18, wherein the control circuit further operates in the burst mode based on the burst signal being in the enabled state and the zero current signal being in the enabled state;
wherein the burst mode starts at the high-side driving signal in the disabled state and ends at the low-side driving signal in the enabled state.

20. The power conversion circuit as claimed in claim 19, wherein the second current detection circuit comprises:
a first comparison circuit, comparing a voltage of the second detection node and an upper threshold voltage to generate the over-current signal; and
a second comparison circuit, comparing the voltage of the second detection node and a zero current threshold voltage to generate the zero current signal;
wherein when the voltage of the second detection node exceeds the upper threshold voltage or the voltage of the second detection node is lower than the lower threshold voltage, the first comparison circuit sets the over-current signal to the reset state;
wherein when the voltage of the second detection node exceeds the zero current threshold voltage, the second comparison circuit sets the zero current signal to the enabled state;
wherein the zero current threshold voltage slightly exceeds zero.

21. A control method for controlling a power conversion circuit, wherein the power conversion circuit comprises a resonant capacitor coupled between a resonant node and a ground, a transformer comprising a primary coil and a secondary coil, a high-side transistor providing an input voltage to a switch node, a low-side transistor coupling the switch node to the ground, a rectification circuit converting energy of the secondary coil to an output voltage, and a feedback circuit generating a feedback voltage based on the output voltage, wherein the primary coil is coupled between the switch node and the resonant node, wherein the control method comprises:
driving the high-side transistor and the low-side transistor based on the feedback voltage, the output voltage, and a current flowing through the resonant capacitor;
determining whether the output voltage is lower than an output threshold;
when it is determined that the output voltage is lower than the output threshold, using the rectification circuit to half-wave rectify the energy of the secondary coil to generate the output voltage; and
when it is determined that the output voltage is not less than the output threshold, using the rectification circuit to full-wave rectify the energy of the secondary coil to generate the output voltage.

22. The control method as claimed in claim 21, wherein the secondary coil comprises a first secondary coil and a second secondary coil;
wherein when the output voltage is lower than the output threshold, using the rectification circuit to convert the energy of either the first secondary coil or the second secondary coil into the output voltage;
wherein when the output voltage is not less than the output threshold, using the rectification circuit to convert the energy of both the first secondary coil and the second secondary coil into the output voltage.

23. The control method as claimed in claim 21, wherein the transformer further comprises an auxiliary coil coupled between an auxiliary node and the ground, wherein the control method further comprises:
using a divider to divide a voltage of the auxiliary node to generate a reflected voltage;
determining whether the reflected voltage is lower than a low voltage threshold;
when it is determined that the reflected voltage is lower than the low voltage threshold, operating the power conversion circuit in a flyback mode; and
when it is determined that the reflected voltage is not less than the low voltage threshold, operating the power conversion circuit in a non-flyback mode;
when the low-side transistor is turned on, transitioning the power conversion circuit from the flyback mode to the non-flyback mode or from the non-flyback mode to the flyback mode;
wherein the reflected voltage is related to the output voltage.

24. The control method as claimed in claim 23, wherein the step of determining whether the reflected voltage is lower than the low voltage threshold further comprises:
sampling the reflected voltage to store as a sampling voltage based on the low-side transistor being turned on;
sampling the reflected voltage to store as a hold voltage based on the low-side transistor being turned off;
using a comparator to compare the hold voltage and the low voltage threshold to generate a determination signal, wherein when the hold voltage is not less than the low voltage threshold, the determination signal is in an enabled state, wherein when hold voltage is lower than the low voltage threshold, the determination signal is in a disabled state;
latching the determination signal as a mode signal based on a high-side dead time of the high-side transistor;
operating the power conversion circuit in the non-flyback mode when the mode signal is in the enabled state; and
operating the power conversion circuit in the flyback mode when the mode signal is in the disabled state.

25. The control method as claimed in claim 23, further comprising:
using a first current detection circuit to detect a current flowing through the resonant capacitor to generate a current detection signal;
integrating the current detection signal based on a reference voltage to generate an integrated signal;
full-wave rectifying the integrated signal to generate a rectified signal; and
driving the high-side transistor and the low-side transistor based on the rectified signal;
wherein the first current detection circuit comprises a first capacitor and a first resistor;
wherein the first capacitor is coupled between the resonant node and a first detection node, and the first resistor is coupled between the first detection node and the ground;
wherein the current detection signal is generated at the first detection node;
wherein a second capacitor is coupled between the first detection node and a second detection node.

26. The control method as claimed in claim 25, further comprising:
using a base voltage as a DC level to full-wave rectify the integrated signal to generate the rectified signal; and
comparing the rectified signal and a first threshold voltage to generate a crossover signal;
wherein the base voltage is equal to a sum of the reference voltage and an offset voltage;
wherein the first threshold voltage slightly exceeds the base voltage.

27. The control method as claimed in claim 26, further comprising:
gradually increasing a soft-start voltage to the feedback voltage in a predetermined period;
converting the soft-start voltage to a compensation voltage; and
subtracting a sawtooth wave from the compensation voltage to generate a compensation signal;
wherein when the soft-start voltage is lower than the feedback threshold voltage, the compensation voltage is equal to the feedback threshold voltage;
wherein when the soft-start voltage is not less than the feedback threshold voltage, the compensation voltage is equal to the soft-start voltage.

28. The control method as claimed in claim 27, further comprising:
when the rectified signal is lower than the first threshold voltage, setting the crossover signal to a disabled state;
when the rectified signal is not less than the first threshold voltage, setting the crossover signal to an enabled state;
in response to the crossover signal transitioning from the disabled state to the enabled state, setting a phase signal to the enabled state; and
in response to the rectified signal exceeding the compensation signal, setting the phase signal to the disabled state during a high-side dead time and a low-side dead time;
wherein the low-side dead time is a period from when the high-side transistor is turned off to when the low-side transistor is turned on;
wherein the high-side dead time is a period from when the low-side transistor is turned off to when the high-side transistor is turned on.

29. The control method as claimed in claim 28, further comprising:
when the high-side transistor is turned on, the phase signal is in the enabled state, and the power conversion circuit operates in the non-flyback mode, turning off the high-side transistor in response to the rectified signal exceeding the compensation signal;
when the high-side transistor is turned on, the phase signal is in the enabled state, and the power conversion circuit operates in the flyback mode, turning off the high-side transistor in response to a voltage of the second detection node exceeding the compensation signal;
when the high-side transistor is turned off, turning on the low-side transistor after the low-side dead time;
when the low-side transistor is turned on, the phase signal is in the enabled state, and the power conversion circuit operates in the non-flyback mode, turning off the low-side transistor in response to the rectified signal exceeding the compensation signal;
when the low-side transistor is turned on, the phase signal is in the enabled state, and the power conversion circuit operates in the flyback mode, turning off the low-side transistor in response to the voltage of the second detection node exceeding the compensation signal; and
when the low-side transistor is turned off, turning on the high-side transistor after the high-side dead time.

30. The control method as claimed in claim 28, further comprising:
operating the power conversion circuit in a burst mode in response to the feedback voltage being lower than a low-power threshold voltage, wherein the feedback voltage decreases as the output voltage increases;
simultaneously turning off the high-side transistor and the low-side transistor in the burst mode; and
extending a duration of the burst mode in response to output power of the output voltage decreasing.

31. The control method as claimed in claim 30, further comprising:
when the current flowing through the resonant capacitor exceeds a predetermined value, simultaneously turning off the high-side transistor and the low-side transistor; and
when the current flowing through the resonant capacitor is close to zero, turning on the low-side transistor;
wherein the burst mode starts at the high-side transistor being turned off and ends at the low-side transistor being turned on.
